(19) United States
(12) Patent Application Publication
(10) Pub. No.: US 2006/0073006 A1
(43) Pub. Date: Apr. 6, 2006

(54) Method and apparatus for supplying empty-bag group

(75) Inventors: Iwao Ikemoto, Iwakuni-shi (JP); Masanori Yasuhira, Iwakuni-shi (JP)

Correspondence Address: KODA & ANDROLIA, 2029 CENTURY PARK EAST, SUITE 1140, LOS ANGELES, CA, 90067, US

(73) Assignee: Toyo Jidoki Co., Ltd.

(21) Appl. No.: 11/229,274

(22) Filed: Sep. 15, 2005

(30) Foreign Application Priority Data
Sep. 15, 2004 (JP) 2004-268778
Nov. 18, 2004 (JP) 2004-333874

(51) Int. Cl. B65G 57/00

(52) U.S. Cl. 414/789.9

(57) ABSTRACT

A method and apparatus for supplying empty-bag group including a belt conveyor which conveys empty bags manufactured by a bag-making machine, a slide conveyor which conveys empty bags that are supplied from the belt conveyor at a specified pitch with the bag bottoms facing forward and which releases these bags from the front end of slide conveyor, and a stacking conveyor which receives the empty bags that are released from the slide conveyor; the front end position of the slide conveyor being movable and caused to move toward the bag mouths intermittently by a specified distance at a time at the above-described pitch, resulting in that an empty-bag group in which empty bags are stacked with the upper empty bags being successively shifted toward the bag mouths by a specified distance at a time is formed on the stacking conveyor.

### BACKGROUND OF THE INVENTION

1. Field of the Invention

The present invention relates to a method for supplying empty-bag groups manufactured by a bag-making machine to a conveyor magazine type bag supply apparatus of a bag filling packaging machine, and to an apparatus for supplying empty-bag group used in this method. In particular, the present invention relates to a method and apparatus for supplying empty-bag group that can be appropriately used in a bag-making and packaging machine in which a bag filling packaging machine is installed on the downstream side of the bag-making machine.

2. Description of the Related Art

As described in Japanese Patent No. 2,982,643 and Japanese Patent Application Laid-Open (Kokai) Nos. H8-337217, 2000-191156 and 2004-42447, in a conveyor magazine type bag supply apparatus, empty bags are stacked on a conveying means such as a conveyor or the like with the bag mouths facing forward (a group comprising numerous empty bags that are thus stacked is called an “empty-bag group”), the empty bags are shifted a little at a time in the direction of length so that the uppermost bag in the stack is located on the forward side (in a cascade configuration), and the bags are successively removed in order from the empty bag in the foremost position and supplied to a bag filling package machine while being fed forward by the conveying means. Such an apparatus is in itself universally known.

Conventionally, empty bags manufactured by bag makers have generally been formed into bundles (empty-bag groups) in which a specified number of bags (e.g., 100 bags) are stacked, and these bundles have been tied. Then, numerous bundles of bags are packed in cardboard, and are transported to the package maker in this form. At the package maker, the cardboard packages of empty bags are opened by hand, and the bundles of empty bags are removed one bundle at a time. These bundles are carried to a conveyor magazine type empty-bag bag supply apparatus, the ties of the bundles are opened, the empty-bag groups are placed on the conveyor, and the stacked configuration is adjusted to a cascade configuration.

In Japanese Patent No. 2,982,643, a series of methods is disclosed in which numerous tied bundles are packed into a bag shipping container, the empty bags are shipped to the package maker in this form; then, at the package maker, the bundles of empty bags are removed from the bag shipping container and place in a bag bundle magazine, the bag bundles are removed from this bag bundle magazine one bundle at a time and accommodated in a bag conveying tray, the ties of the bundles are opened while the bag bundles are being conveyed, the empty-bag groups are removed from the tray in the vicinity of a conveyor magazine type empty-bag supply apparatus and placed on the conveyor of this conveyor magazine type empty-bag supply apparatus, and the stacked configuration is adjusted to a cascade configuration by means of a feed-out belt.

In Japanese Patent Application Laid-Open (Kokai) No. H8-337217, empty-bag groups that are stacked in the vertical direction are stocked in the vicinity a conveyor magazine type empty-bag supply apparatus, and they are appropriately supplied to the conveyor magazine type empty-bag supply apparatus (it is necessary at the time of replenishment to adjust the stacked configuration to a cascade configuration).

In Japanese Patent Application Laid-Open (Kokai) No. 2000-191156, empty-bag groups whose stacked configuration has been adjusted to a cascade configuration are stocked in the vicinity of a conveyor magazine type empty-bag supply apparatus, and they are appropriately replenished in this conveyor magazine type empty-bag supply apparatus.

In Japanese Patent Application Laid-Open (Kokai) No. 2004-42447, empty bags that are successively fed out from the bag-making machine in a bag-making and packaging machine in which a bag filling packaging machine is installed on the downstream side of a bag-making machine are vertically stacked before a conveyor magazine type empty-bag supply apparatus, and these stacked empty-bag groups are supplied to the conveyor magazine type empty-bag supply apparatus (at the time of supply, it is necessary to adjust the stacked configuration to a cascade configuration).

In all of the conventional methods, the stacked configuration of the stacked empty-bag groups is adjusted to a cascade configuration either by hand or by means of a special device in the stage in which the empty bags (manufactured by a bag-making machine) are vertically stacked and replenished in a conveyor magazine type empty-bag supply apparatus, and the empty-bag groups are then supplied to the conveyor magazine type empty-bag supply apparatus.

The above-described conventional methods have the problems as follows:
(a) When empty-bag groups are supplied to the conveyor magazine type bag supply apparatus, it is necessary to alter the stacked configuration of the empty-bag groups from a vertically stacked configuration to a cascade configuration. It is bothersome to perform this work by hand, and a special apparatus is required if this work is performed automatically as described in Japanese Patent No. 2,982,643. Furthermore, in the feed-out belt used in Japanese Patent No. 2,982,643, a stacked configuration of zipper-equipped bags cannot be adjusted to a cascade configuration.
(b) In cases where the empty bags are zipper-equipped bags or self-standing bags, the thickness differs between the bag mouth parts and bag bottom parts; accordingly, when numerous bags are stacked vertically with the bags arranged in the same orientation, the stacked state tends to break down during stocking or conveying.

### SUMMARY OF THE INVENTION

The present invention is devised in the light of such problems encountered in the prior art.

It is, therefore, an object of the present invention to provide an empty-bag group supply method and an empty-bag group supply apparatus in which the empty-bag groups are supplied to a conveyor magazine type bag supply apparatus without any need to alter the stacked configuration, and even in the case of zipper-equipped bags and self-standing bags, the stacked state of such bags during stocking and conveying can be stabilized.

The present invention is based on an idea that if the stacked configuration of empty-bag groups is adjusted to a cascade configuration when the empty-bag groups are placed on the conveyor of a conveyor magazine type bag supply apparatus, then it should be possible to stack the empty-bag groups in such a configuration from the beginning in the stage where the empty-bag groups leave the bag-making machine, so that the empty-bag groups are supplied to the conveyor magazine type bag supply apparatus or stocked or conveyed, with the empty-bag groups maintained “as is” in such a stacked configuration.

The above object is accomplished by a set of unique steps of the present invention for a method for supplying empty-bag group; and in the present invention, the method comprises the steps of:
feeding empty bags manufactured by a bag-making machine onto a stacking conveyor one at a time with a direction of length of bags oriented parallel to a conveying direction of the stacking conveyor, so that a specified number of bags are stacked on the stacking conveyor with upper bags being successively shifted by a specified distance at a time in the direction of length of bags so that the bags are shifted in a direction of bag mouths, and
conveying a resulting stacked empty-bag group by the stacking conveyor, thus supplying the empty-bag group to a conveyor magazine type bag supply apparatus of a bag filling packaging machine with bag mouth sides of the bags facing forward, either via another conveyor interposed or without another conveyor.

The above method is suitably applicable to a bag-making and packaging machine in which a bag filling packaging machine is installed on the downstream side of a bag-making machine.

The above method can be executed by the below-described apparatuses for supplying empty-bag groups of the present invention.

(a) An apparatus for supplying empty-bag group that comprises a first conveyor which is driven in a conveying movement at a constant speed and conveys empty bags parallel to a direction of length of bags with bottom sides of bags facing forward and releases the bags from a front end thereof; an empty-bag supply means which supplies empty bags manufactured by a bag making machine to the first conveyor one at a time at a specified pitch (number of times per minute=bags per minute); and a stacking conveyor which is provided beneath the first conveyor with a conveying direction of the stacking conveyor oriented parallel to that of the first conveyor, so that the stacking conveyor receives empty bags that are released from the first conveyor; and
in this structure:
   the front end position of the first conveyor can move back and forth along a conveying direction thereof, and
   front end position of the first conveyor is caused to move toward bag mouths side either continuously or intermittently by a specified distance at a time at the specified pitch, thus forming an empty-bag group, in which a specified number of empty bags are stacked with upper bags successively shifted a specified distance at a time in a direction of bag mouths, on the stacking conveyor.

In this apparatus, a slide conveyor whose front end is slidable back and forth along the conveying direction of the first conveyor intermittently and/or continuously can be used as the first conveyor.

(b) An apparatus for supplying empty-bag group that comprises an empty-bag supply means which supplies empty bags manufactured by a bag making machine to a specified position one at a time at a specified pitch; and a stacking conveyor which receives empty bags from the empty-bag supply means, and
in this structure:
   the conveying direction of the stacking conveyor is set to be parallel to a direction of length of the empty bags; and
   the stacking conveyor is caused to make a conveying operation toward bottoms side of bags either continuously at a specified speed or intermittently by a specified distance at a time at the specified pitch, thus forming an empty-bag group, in which a specified number of empty bags are stacked with upper bags successively shifted a specified distance at a time in a direction of bag mouths, on the stacking conveyor.

In the above apparatus, an empty-bag group such as that described above can also be formed by way of causing the stacking conveyor as a whole to move toward the bottoms side of the bags either continuously or intermittently by a specified distance at a time at the above-described pitch.

(c) An apparatus for supplying empty-bag group that comprises an empty-bag supply means which supplies empty bags manufactured by a bag making machine to a specified position one at a time at a specified pitch; an empty-bag holding device which can make a reciprocating motion parallel to a direction of length of the empty bags, is alternately positioned in a fixed initial position and a reciprocating position, and has a shutter means that can be freely opened and closed, so that the empty-bag holding device accommodates and holds an empty bag when the shutter means is closed and releases an empty bag downward when the shutter means is opened; and a stacking conveyor which is provided beneath the empty-bag holding device so that the conveying direction of the stacking conveyor is parallel to the movement direction of the empty-bag holding device and so that the stacking conveyor receives the empty bag released from the empty-bag holding device; and
in this structure, the empty-bag holding device:
   receives an empty bag from the empty-bag supply means in a state in which the shutter means is closed in the initial position,
   then moves to the reciprocating position,
   opens the shutter means in the reciprocating position and releases the empty bag onto the stacking conveyor, and
   shifts the reciprocating position toward bag mouths side by a specified distance with each reciprocating motion,
   thus forming an empty-bag group, in which a specified number of empty bags are stacked with upper bags successively shifted a specified distance at a time in a direction of bag mouths, on the stacking conveyor.

The above object is also accomplished by another set of unique steps of the present invention for a method for supplying empty-bag group; and in the present invention, the method comprises the steps of:
stacking empty bags manufactured by a bag-making machine in a specified number inside an empty-bag stacking device with upper bags being successively shifted by a specified distance at a time in a direction of length of bags so that the bags are shifted in a direction of bag mouths;
feeding a stacked assembly thus obtained onto a stacking conveyor with the direction of length of bags oriented parallel to a conveying direction of the stacking conveyor;
repeating the above steps a plurality of times;
feeding the lowermost bag of a stacked assembly, which is fed next, with the bag being shifted by the specified distance in a direction of bag mouth with respect to an uppermost bag of a previously fed stacked assembly, so that an empty-bag group consisting of a plurality of stacked assemblies is stacked on the stacking conveyor; and
conveying the empty-bag group by the stacking conveyor, thus supplying the empty-bag group to a conveyor magazine type bag supply apparatus of a bag filling packaging machine with bag mouth sides of bags facing forward, either via another conveyor interposed or without another conveyor.

The above method is suitably applicable to a bag-making and packaging machine in which a bag filling packaging machine is installed on the downstream side of a bag-making machine.

The above method can be executed by the below-described apparatus for supplying empty-bag groups of the present invention.

(d) An apparatus for supplying empty-bag group that comprises:
an empty-bag supply means which supplies empty bags manufactured by a bag making machine to a specified position one at a time at a specified pitch;
an empty-bag stacking device which can make a reciprocating motion parallel to a direction of length of said empty bags, and has a shutter means that can be freely opened and closed, so that said empty-bag stacking device closes said shutter means to receive empty bags from said empty-bag supply means and stacks a specified number of said empty bags, and said empty-bag stacking device opens said shutter means to release a stacked assembly thus obtained downward; and
a stacking conveyor which is provided beneath the empty-bag stacking device so that the conveying direction of the stacking conveyor is parallel to the movement direction of the empty-bag stacking device, so that the stacking conveyor receives stacked assemblies released from the empty-bag stacking device and stacks an empty-bag group comprising a plurality of stacked assemblies; and

in this apparatus:
the empty-bag stacking device is caused to move toward bottoms side of bags either continuously at a constant speed or intermittently by a specified distance at a time at the specified pitch when empty bags are received from the empty-bag supply means, thus forming a stacked assembly of empty bags, in which a plurality of empty bags are stacked with upper bags being successively shifted a specified distance at a time toward bag mouths, inside the empty-bag stacking device; and
the stacking conveyor makes a conveying operation each time one of the stacked assemblies is received, and stacks the stacked assemblies on the stacking conveyor so that lowermost bag of a stacked assembly that is received next is shifted by a specified distance in a direction of bag mouth with respect to an uppermost bag of a stacked assembly received previously.

In the above-described apparatuses (a) through (d), the stacking conveyor is connected to the rear portion of a conveyor of a conveyor magazine type bag supply apparatus of a bag filling packaging machine either directly or via another conveyor or the like.

In the apparatuses of the present invention, “front” and “back” with respect to the conveyor refers to the feeding direction of the empty-bag groups during ordinary operation of the conveyor.

The above-described apparatuses (a) through (d) can be modified in an apparatus for supplying empty-bag group in which a second conveyor that receives empty-bag groups from the above-described stacking conveyor is provided in front of the above-described stacking conveyor, two sets each consisting of the stacking conveyor and second conveyor are installed side by side, these conveyors are set so as to make a reciprocating motion together in the horizontal plane perpendicular to the conveying direction, and the stacking conveyors are alternately positioned in the empty-bag or stacked assembly receiving position as a result of this reciprocating motion.

In this modified apparatus, the second conveyor (of the same set) that is disposed in front of the stacking conveyor positioned in the above-described receiving position is connected to the rear portion of a conveyor of the conveyor magazine type bag supply apparatus of a bag filling packaging machine.

According to this modified apparatus for supplying empty-bag group, the operation as follows is performed: empty bags or stacked assemblies are supplied to one stacking conveyor that is positioned in the above-described receiving position, and the empty-bag groups on the second conveyor that is disposed in front of this stacking conveyor are fed onto the conveyor of the above-described conveyor magazine type bag supply apparatus; meanwhile, empty-bag groups are fed from the other stacking conveyor that is removed from the receiving position onto the second conveyor that is disposed in front of this other stacking conveyor.

The above-described apparatuses (a) through (d) can be further modified in an apparatus for supplying empty-bag group in which a pair of the stacking conveyors are disposed side by side, the stacking conveyors are set so as to make a reciprocating motion together within a horizontal plane perpendicular to the conveying direction, the stacking conveyors are alternately positioned in the stacked assembly receiving position as a result of the reciprocating motion, so that when one of the stacking conveyors is in the receiving position, the other stacking conveyor is in a non-receiving position on either the left or right; and
in this structure:
   a second conveyor which alternatively receives empty-bag groups from the pair of stacking conveyors is disposed in front of the pair of stacking conveyors,
   a conveying direction of the second conveyor is set to be parallel to the conveying direction of the stacking conveyors,
   the second conveyor is devised so as to make a reciprocating motion in a horizontal plane perpendicular to the conveying direction, and
   the second conveyor is alternately positioned by the reciprocating motion in a position in front of the stacking conveyor that is in the non-receiving position.

In this modified apparatus for supplying empty-bag group, when the second conveyor is positioned in a position in front of the stacking conveyor that is in the non-receiving position on either the left or right, the second conveyor is connected to the rear portion of the conveyor of the conveyor magazine type bag supply apparatus of a bag filling packaging machine.

According to this modified apparatus for supplying empty-bag group, empty bags or stacked assemblies are supplied to one of the stacking conveyors, which is positioned in the above-described receiving position, while empty-bag groups are fed from the other stacking conveyor, which is removed from the receiving position, onto the second conveyor that is positioned in front of this stacking conveyor. In this case, the operation as follows is performed: in cases where the second conveyor is connected to the rear portion of a conveyor of the conveyor magazine type bag supply apparatus of the bag filling packaging machine, empty-bag groups are fed to this conveyor, while in cases where the second conveyor is not connected to the rear portion of a conveyor of the conveyor magazine type bag supply apparatus of the bag filling package apparatus, then empty-bag groups are fed to this conveyor after first positioning the second conveyor after this conveyor.

The above object is further accomplished by another set of unique steps of the present invention for a method for supplying empty-bag group; and in the present invention, the method comprises the steps of:
feeding empty bags manufactured by a bag making machine one at a time into a stacking tray, so that these empty bags are stacked in a specified number on the tray with upper bags being successively shifted by a specified distance at a time in a direction of length of bags so that the bags are shifted in a direction of bag mouths;
conveying a resulting empty-bag group that is stacked inside the stacking tray together with the stacking tray;
removing the empty-bag group inside the stacking tray; and
supplying the empty-bag group to a conveyor magazine type bag supply apparatus of a bag filling packaging machine with bag mouth sides of the bags facing forward.

In this method, the stacking tray is utilized mainly as a conveying casing in cases where the bag-making machine and a bag filling packaging machine are not connected as in a bag making and packaging machine. Such cases includes, for instance, that a bag-making machine and bag filling packaging machine are provided in separate-locations and that empty-bag groups manufactured by a bag maker are sent to a package maker.

The above method can be executed by the below-described apparatuses for supplying empty-bag groups of the present invention.

(e) An apparatus for supplying empty-bag group that comprises a first conveyor which is driven in a conveying operation at a constant speed so that the first conveyor conveys empty bags parallel to a direction of length of bags and toward a bottom side of bags and releases the bags from a front end thereof; an empty-bag supply means which supplies empty bags manufactured by a bag-making machine one at a time at a specified pitch to the first conveyor; a stacking tray which is provided beneath the first conveyor and receives empty bags released from the first conveyor; and a conveying means which conveys the stacking tray; and
in this structure
   the front end position of the first conveyor is movable back and forth along a conveying direction of the first conveyor, and
   the front end position is caused to move toward bag mouths side either continuously or intermittently by a specified distance at a time at the specified pitch, thus forming an empty-bag group, in which a specified number of empty bags are stacked with upper bags being successively shifted by a specified distance in a direction of bag mouths, on the stacking tray.

In this apparatus, a slide conveyor whose front end is slidable back and forth along the conveying direction intermittently and/or continuously can be used as the first conveyor.

(f) An apparatus for supplying empty-bag group that comprises an empty-bag supply means which supplies empty bags manufactured by a bag-making machine to a specified position one at a time at a specified pitch; a stacking tray to which empty bags are supplied from the empty-bag supply means; and a moving means which moves the stacking tray; and
in this structure:
   the direction of movement of the stacking tray caused by the moving means is set to be parallel to a direction of length of the empty bags, and
   the moving means moves the stacking tray toward bottoms side of empty bags either continuously at a specified speed or intermittently by a specified distance at a time at the specified pitch, thus forming an empty-bag group, in which a specified number of empty bags are stacked with upper bags being successively shifted a specified distance at a time in a direction of bag mouths, on the stacking tray.

(g) An apparatus for supplying empty-bag group that comprises an empty-bag supply means which supplies empty bags manufactured by a bag making machine to a specified position one at a time at a specified pitch; an empty-bag holding device which can make a reciprocating motion parallel to a direction of length of the empty bags, is alternately positioned in a fixed initial position and a reciprocating position, and has a shutter means that can be freely opened and closed, so that the empty-bag holding device accommodates and holds an empty bag when the shutter means is closed and releases an empty bag downward when the shutter means is opened; a stacking tray which is provided beneath the empty-bag holding device and receives an empty bag released from the empty-bag holding device; and a conveying means which conveys the stacking tray; and
in this structure, the empty-bag holding device:
   receives an empty bag from the empty-bag supply means in a state in which the shutter means is closed in the initial position,
   moves to the reciprocating position,
   opens the shutter means in the reciprocating position and releases the empty bag onto the stacking tray, and
   shifts the reciprocating position toward bag mouths side by a specified distance with each reciprocating motion,
   thus forming an empty-bag group, in which a specified number of empty bags are stacked with upper bags successively shifted a specified distance at a time in a direction of bag mouths, on the stacking tray.

The above object is further accomplished by still another set of unique steps of the present invention for a method for supplying empty-bag group; and in the present invention, the method comprises the steps of:
stacking empty bags manufactured by a bag making machine in a specified number inside an empty-bag stacking device with upper bags being successively shifted by a specified distance at a time in a direction of length of bags so that the bags are shifted in a direction of bag mouths;
feeding a stacked assembly thus obtained onto a stacking tray with a direction of length of bags oriented parallel to a conveying direction of the stacking tray;
repeating the above steps a plurality of times;
feeding the lowermost bag of a stacked assembly, which is fed next, with the bag being shifted by the specified distance in a direction of bag mouth with respect to an uppermost bag of a previously fed stacked assembly, so that an empty-bag group consisting of a plurality of stacked assemblies is stacked on the stacking tray;
conveying the empty-bag group together with the stacking tray;
removing the empty-bag group inside the stacking tray, and
supplying the empty-bag group to a conveyor magazine type bag supply apparatus of a bag filling packaging machine with bag mouth sides of bags facing forward.

The above method can be executed by the below-described apparatus for supplying empty-bag groups of the present invention.

(h) An apparatus for supplying empty-bag group that comprises an empty-bag supply means which supplies empty bags manufactured by a bag making machine to a specified position one at a time at a specified pitch; an empty-bag stacking device which can make a reciprocating motion parallel to a direction of length of the empty bags, and has a shutter means that can be freely opened and closed, so that the empty-bag stacking device closes the shutter means to receive empty bags from the empty-bag supply means and stacks a specified number of the empty bags, and the empty-bag stacking device opens the shutter means to release a stacked assembly thus obtained downward; a stacking tray which is provided beneath the empty-bag stacking device so that the stacking tray receives a stacked assembly of empty bags that are released from the empty-bag stacking device and stacks an empty-bag group comprising a plurality of stacked assemblies; and a tray conveyor which conveys the stacking tray and is disposed so that a conveying direction of the tray conveyor and a movement direction of the empty-bag stacking device are parallel; and

in this structure:
the empty-bag stacking device is caused to move toward bottoms side of bags either continuously at a constant speed or intermittently by a specified distance at a time at the specified pitch when empty bags are received from the empty-bag supply means, thus forming a stacked assembly of empty bags, in which a plurality of empty bags are stacked with upper bags being successively shifted a specified distance at a time toward bag mouths, inside the empty-bag stacking device; and
the tray conveyor makes a conveying operation each time one of the stacked assemblies is received, and stacks the stacked assemblies on the stacking tray so that lowermost bag of a stacked assembly that is received next is shifted by a specified distance in a direction of bag mouth with respect to an uppermost bag of a stacked assembly received previously.

As seen from the above, according to the present invention, when the empty bags leave the bag-making machine, they are stacked with the upper bags being successively shifted a specified distance at a time in the direction of length of the empty bags so that these bags are shifted in the direction of the bag mouths, and the stacked empty-bag groups, with this configuration maintained “as is”, are supplied to a conveyor magazine type bag supply apparatus, or stocked or conveyed.

Accordingly, in the present invention, there is no need to alter the stacked configuration of the empty-bag groups when these empty-bag groups are supplied to the conveyor magazine type bag supply apparatus. Moreover, since the bags are stacked so that the bags are shifted slightly in the direction of length of the bags, the stacked state of the empty-bag groups during stocking or conveying can be stabilized even in the cases that the bags are zipper-equipped bags or self-standing bags.

### BRIEF DESCRIPTION OF THE DRAWINGS

FIG. 1 is a perspective view of the apparatus for supplying empty-bag group according to the present invention;

FIG. 2 is a side view of the stopper disposed on the slide conveyor of the apparatus for supplying empty-bag group;

FIG. 3 is a front view thereof;

FIG. 4 is a side view of the empty-bag holding device disposed on the slide conveyor;

FIG. 5 is a front view (partially in section) thereof;

FIG. 6 is a perspective view of another apparatus for supplying empty-bag group according to the present invention;

FIG. 7 is a perspective view of still another apparatus for supplying empty-bag group according to the present invention;

FIG. 8 is a perspective view of still another apparatus for supplying empty-bag group according to the present invention;

FIG. 9 is a perspective view of still another apparatus for supplying empty-bag group according to the present invention;

FIG. 10 is a perspective view of still another apparatus for supplying empty-bag group according to the present invention;

FIG. 11 is a perspective view of still another apparatus for supplying empty-bag group according to the present invention; and

FIG. 12 is a perspective view of still another apparatus for supplying empty-bag group according to the present invention.

### DETAILED DESCRIPTION OF THE INVENTION

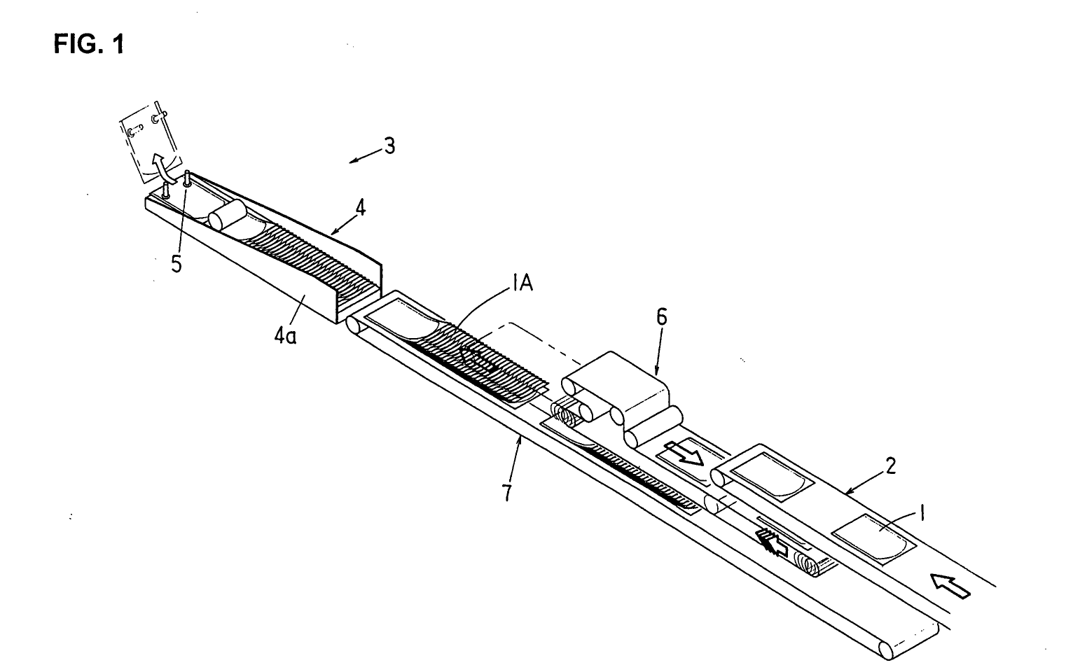

The present invention will be concretely described below with reference to FIGS. 1 through 12.

The apparatus for supplying empty-bag group shown in FIG. 1 is applied to a bag making and packaging machine in which a bag filling packaging machine is installed on the downstream side of a bag-making machine (for example, see the above-described Japanese Patent Application Laid-Open (Kokai) No. 2004-42447); and this apparatus supplies empty bags 1 that are manufactured by a bag-making machine (not shown in the drawings), placed on a belt conveyor 2 and conveyed one bag at a time at equal intervals to the conveyor magazine type bag supply apparatus 3 of a bag filling packaging machine (the main body of the bag filling packaging machine is not shown in the drawings; only the belt conveyor 4 and bag supply platen 5 of the conveyor magazine type bag supply apparatus are shown in the figures).

This apparatus for supplying empty-bag group comprises a belt conveyor 2 (an empty-bag supply means referred to in the present invention), a slide conveyor 6 which is disposed parallel to the belt conveyor 2 in a position beneath this belt conveyor 2, and a stacking conveyor 7 which is disposed parallel to the slide conveyor 6 in a position beneath the slide conveyor 6. The front end of the stacking conveyor 7 is connected in series with the rear end of the belt conveyor 4 of the conveyor magazine type bag supply apparatus 3.

The belt conveyor 2 is caused to make a conveying operation at a constant speed and supplies empty bags 1 one at a time at a constant pitch (number of times per minute=bags per minute) to the slide conveyor 6 (the empty bags 1 are caused to drop into the slide conveyor 6 from the front end). The empty bags 1 on the belt conveyor 2 are oriented so that the bag mouths face forward, and so that the direction of length of the bags is set to be parallel to the conveying direction of the belt conveyor 2.

The slide conveyor 6 is caused to make a conveying operation at a constant speed in the opposite direction from the conveying direction of the belt conveyor 2, and it is devised so that the front end of this slide conveyor 6 is slidable back and forth along the conveying direction in an intermittent manner. This slide conveyor 6 conveys the empty bags 1 supplied from the belt conveyor 2 with the bottoms of the bags facing forward and releases these empty bags from the front end (i.e., causes the empty bags to drop onto the belt of the stacking conveyor 7). Slide conveyors of this type (also called shuttle conveyors) are universally known conveyors, as described in, for example, Japanese Patent Application Laid-Open (Kokai) No. H9-272626 and Japanese Patent Application Laid-Open (Kokai) No. H10-17134.

The stacking conveyor 7 is caused to make a conveying operation in the opposite direction from the conveying direction of the slide conveyor 6.

It is desirable that guide plates (see the empty-bag guide 4a disposed on the belt conveyor 4 of the above-described conveyor magazine type bag supply apparatus 3) that guide both side edges of the empty bags 1 or empty-bag groups 1A be disposed along the conveying direction on both sides of the belt conveyor 2, slide conveyor 6 and stacking conveyor 7.

In the above-described apparatus for supplying empty-bag group, the slide conveyor 6 is set so that the front end position of this slide conveyor 6 moves toward the bag mouths side (i.e., rearward) intermittently by a specified distance at a time at the above-described pitch (i.e., with the release of each empty bag 1).

The stacking conveyor 7 is stopped until the number of empty bags 1 released from the slide conveyor 6 reaches a specified number of bags. Accordingly, the upper bags are successively shifted a specified distance at a time in the direction of the bag mouths (this is the same as the one-time movement distance of the slide conveyor 6) so that an empty-bag group 1A is formed on the stacking conveyor 7.

When this empty-bag group 1A is formed, the stacking conveyor 7 is immediately caused to make a conveying operation by a specified distance (length of the empty-bag group 1A in the conveying direction +α), so that the empty-bag group 1A on the stacking conveyor 7 is fed forward. In this case, the foremost empty-bag group 1A on the stacking conveyor 7 is supplied to the belt conveyor 4 of the conveyor magazine type bag supply apparatus 3. Meanwhile, the front end position of the slide conveyor 6 returns to the initial position (the position where the lowermost empty bag in the empty-bag group 1A is released, i.e., the position where intermittent movement is initiated). Then, the intermittent movement of the slide conveyor 6 again begins, and empty bags 1 are stacked on the stacking conveyor 7.

In the above-described apparatus for supplying empty-bag group, the stacking conveyor 7 is stopped during the stacking of the empty-bag group 1A, so that only the slide conveyor 6 is operated; and the front end position is caused to move toward the bag mouths side (i.e., rearward) by a specified distance at a time at a specified pitch.

It is also possible to perform the types of operations as follows:

(a) Instead of causing the front end position of the slide conveyor 6 to move intermittently at a specified pitch, this front end position can be caused to move continuously at a specified speed. This movement speed may be the same as the mean movement speed in the case of intermittent movement if the same empty-bag group 1A is to be obtained (the amount of shift between empty bags that are adjacent to each other above and below is the above-described specified distance).

(b) The stacking conveyor 7 is set so that this conveyor can rotate in the forward and reverse directions, and the stacking conveyor 7 is caused to make a conveying operation toward the bottoms of the bags (rearward) during the stacking of the empty-bag group 1A. The conveying operation in this case may be continuous or may be performed intermittently at the above-described specified pitch. As a result of the stacking conveyor 7 being caused to make a conveying operation in this manner, if the same empty-bag group 1A is to be obtained (here, the amount of shift between empty bags that are adjacent to each other above and below is the above-described specified distance), the movement distance arising from a single intermittent movement of the front end position of the slide conveyor 6 is shortened, or, in the case of continuous movement, the movement speed can be reduced, so that only a short movement distance is required when the front end position of the slide conveyor 6 returns to the initial position following the formation of the empty-bag group 1A, thus allowing a speedy return.

(c) The stacking conveyor 7 is caused to make a conveying operation toward the bag mouths side (i.e., in the forward direction) during the stacking of the empty-bag group 1A. The conveying operation in this case may be continuous or may be performed intermittently at the above-described pitch. As a result of the stacking conveyor 7 being caused to make a conveying operation in this manner, if the same empty-bag group 1A is to be obtained (here, the amount of shift between empty bags that are adjacent to each other above and below is the above-described specified distance), the movement distance arising from a single intermittent movement of the front end position of the slide conveyor 6 is lengthened, or, in the case of continuous movement, the movement speed is increased, so that the movement distance when the front end position of the slide conveyor 6 returns to the initial position following the formation of the empty-bag group 1A is lengthened. On the other hand, since the empty-bag group 1A already present on the stacking conveyor 7 is conveyed forward during the stacking of the new empty-bag group 1A, the conveying distance when the foremost empty-bag group 1A on the stacking conveyor 7 is sent to the belt conveyor 4 of the conveyor magazine type bag supply apparatus 3 following the formation of the new empty-bag group 1A is shortened, so that the empty-bag group 1A can be quickly supplied to the belt conveyor 4. For example, the movement distance of a single intermittent movement of the stacking conveyor 7 or the movement speed in the case of continuous movement can be set so that most of the foremost empty-bag group 1A is conveyed onto the belt conveyor 4 by the time that the stacking of the new empty-bag group 1A is completed.

(d) Furthermore, in the above-described apparatus for supplying empty-bag group, the slide conveyor 6 in particular is used in order to move the front end position of the conveyor supplying empty bags 1 to the stacking conveyor 7 toward the bag mouths side (i.e., forward) either continuously or intermittently by a specified distance at a time at the above-described pitch. However, it is also possible to use an ordinary belt conveyor instead of the slide conveyor 6, and the move this belt conveyor as a whole toward the bag mouths side either continuously at a specified speed or intermittently at a specified pitch.

(e) Furthermore, in the above-described apparatus for supplying empty-bag group, the stacking conveyor 7 is connected to the rear portion of the belt conveyor 4, and empty-bag groups are sent directly to the belt conveyor 4 from the stacking conveyor 7. However, for example, it is also possible to install another belt conveyor between the belt conveyor 4 and the stacking conveyor 7 as a type of buffer (accumulating device).

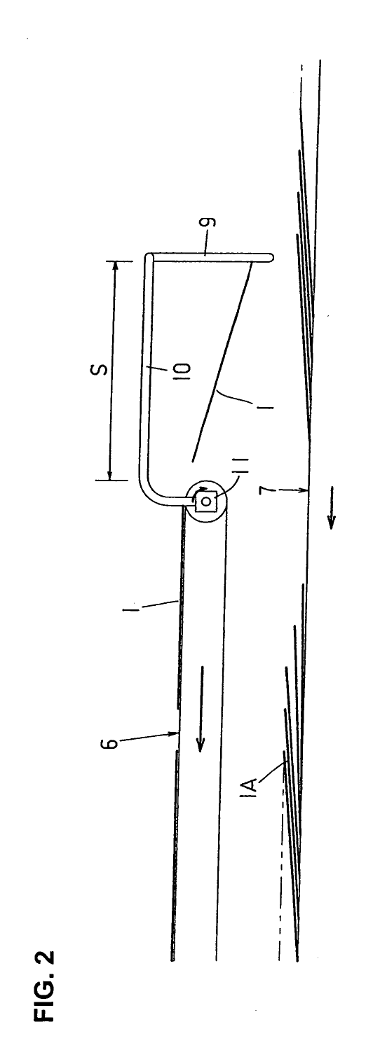

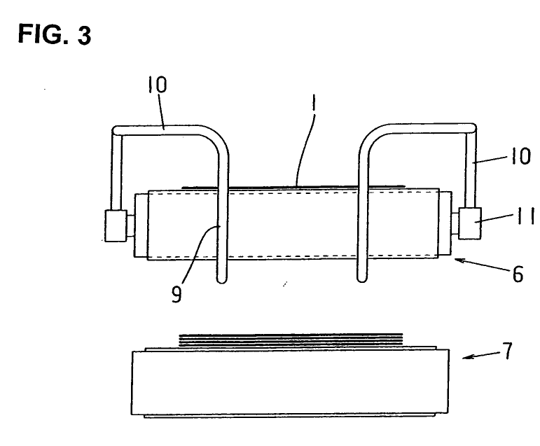

In the above-described apparatus for supplying empty-bag group, it is also possible to install an empty-bag stopper 9 in a position located a specified distance forward of the front end position of the slide conveyor 6 as shown in FIGS. 2 and 3 in order to control the dropping position of the empty bags 1 that are released from the front end of the slide conveyor 6.

This empty-bag stopper 9 extends vertically from a position that is slightly above the conveying surface of the slide conveyor 6 to a point directly above the stacking conveyor 7. An extension part 10 used for attachment extends to the side and rearward from the upper end of this stopper, and is fastened to a roller bearing 11 on the front end of the slide conveyor 6. Even if the front end of the slide conveyor 6 should move (retraction during stacking: see the arrow in FIG. 2), the distance S from this front end position to the empty-bag stopper 9 is maintained at a fixed distance.

If the empty bags 1 are released from the slide conveyor 6 with the above-described distance S set at a value that is slightly larger than the length of the empty bags 1, then the tip ends on the bottoms of the bags will contact the empty-bag stopper 9, so that movement in the forward direction is stopped; then, the empty bags 1 will move along the empty-bag stopper 9 and drop onto the stacking conveyor 7.

Furthermore, the empty-bag stopper 9 may also be disposed on the belt conveyor 2.

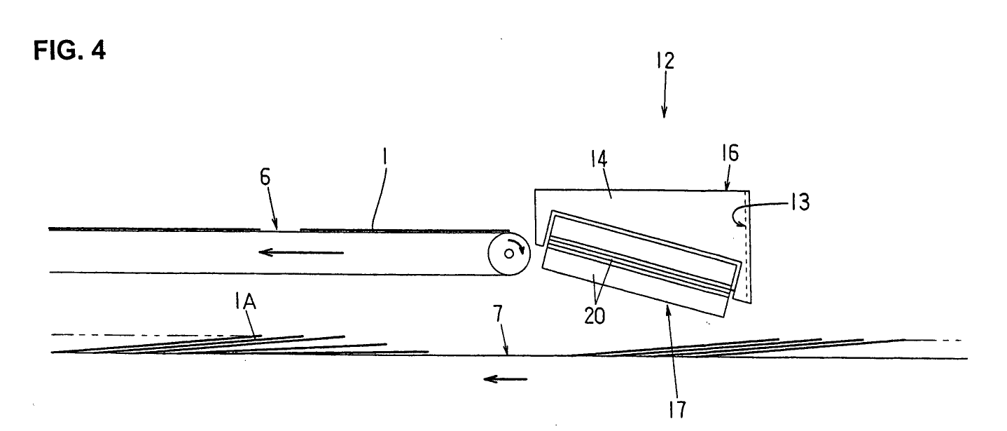

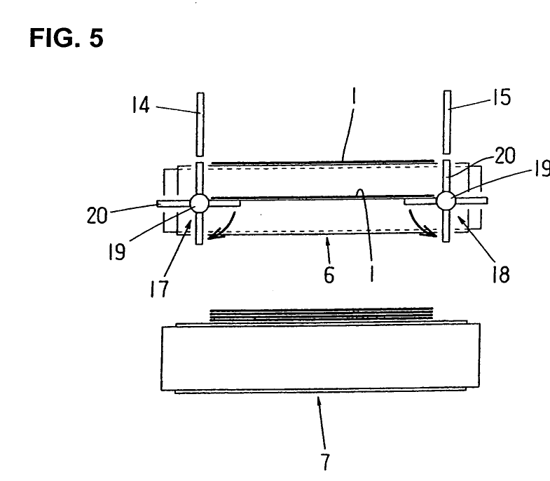

Furthermore, in the above-described apparatus for supplying empty-bag group, it is also possible to dispose an empty-bag holding device 12 in front of the front end position of the slide conveyor 6 as shown in FIGS. 4 and 5 in order to control the dropping position of the empty bags 1 that are released from the front end of the slide conveyor 6.

The empty-bag holding device 12 is attached to the roller bearing 11 (see FIG. 2) on the front end of the slide conveyor 6 by means of a bracket not shown in FIG. 2, so that even if the front end of the slide conveyor 6 should move (retraction movement (shown by the arrow in FIG. 2) during stacking of the empty bags thereon, the positional relationship with this front end does not fluctuate.

As seen from FIGS. 4 and 5, the empty-bag holding device 12 is comprised of a positioning frame 16 that includes a front wall 13 and left and right side walls 14 and 15, a pair of shutter members 17 and 18 which are disposed inside cut-outs formed in the lower portions of the side walls 14 and 15 and which are shaft-supported at both ends thereof, and a driving mechanism (not shown in FIGS. 4 and 5) which causes the shutter members 17 and 18 to rotate 90 degrees at a time in mutually opposite directions in an intermittent movement at the above-described pitch. This driving mechanism is connected to a center shaft 19 (described later).

The left and right side walls 14 and 15 of the positioning frame 16 function as guide plates that guide the left and right edges of the empty bags 1 which are released from the front end of the slide conveyor 6, and the front wall 13 functions as a stopper that is contacted by the tip ends (on the bag bottoms side) of the empty bags 1. The front wall 13 is disposed perpendicular to the conveying direction of the slide conveyor 6 and extends vertically from a position that is slightly above the conveying surface of the slide conveyor 6 to a position that is slightly below the center shaft 19. Furthermore, the distance between the front end of the slide conveyor 6 and the front wall 13 is set so that this distance is slightly greater than the length of the empty bags 1.

The shutter members 17 and 18 have a configuration in which four rectangular plate-form members 20 are respectively attached in a cruciform shape (see FIG. 5) around the periphery of the center shaft 19, with the center shaft 19 being inclined in the forward direction. When the shutter members 17 and 18 stop rotating, the plate-from member 20 face to the left and right (inward and outward) and upward and downward as shown in FIG. 5. In this case, the plate-form members 20 that face upward and downward are positioned directly beneath the left and right side walls 14 and 15 of the positioning frame 16. Furthermore, the height of the plate-form members 20 that face to the left and right (i.e., the height of the positions closest to the slide conveyor 6) is such that these members are positioned slightly below the conveying surface of the slide conveyor 6.

When empty bags 1 are released from the front end of the slide conveyor 6, these bags are moved forward between the two side walls 14 and 15 of the positioning frame 16, the tip ends of the bags on the bottoms side of the bags then contact the front wall 13 so that the movement in the forward direction stops, and the bags drop downward along the front wall 13 and are placed on the left and right plate-form members 20 that face inward. Then, the shutter members 17 and 18 are caused to rotate 90 degrees in mutually opposite directions (as shown by arrows in FIG. 5) by the above-described driving mechanism, so that each empty bag 1 that is placed on the plate-from members 20 drops onto the stacking conveyor 7.

It is desirable that the rotation of the shutter members 17 and 18 (i.e., the dropping of the empty bags 1) be performed while the slide conveyor 6 is stopped.

In addition, the above-described empty-bag holding device can be disposed on the belt conveyor 2.

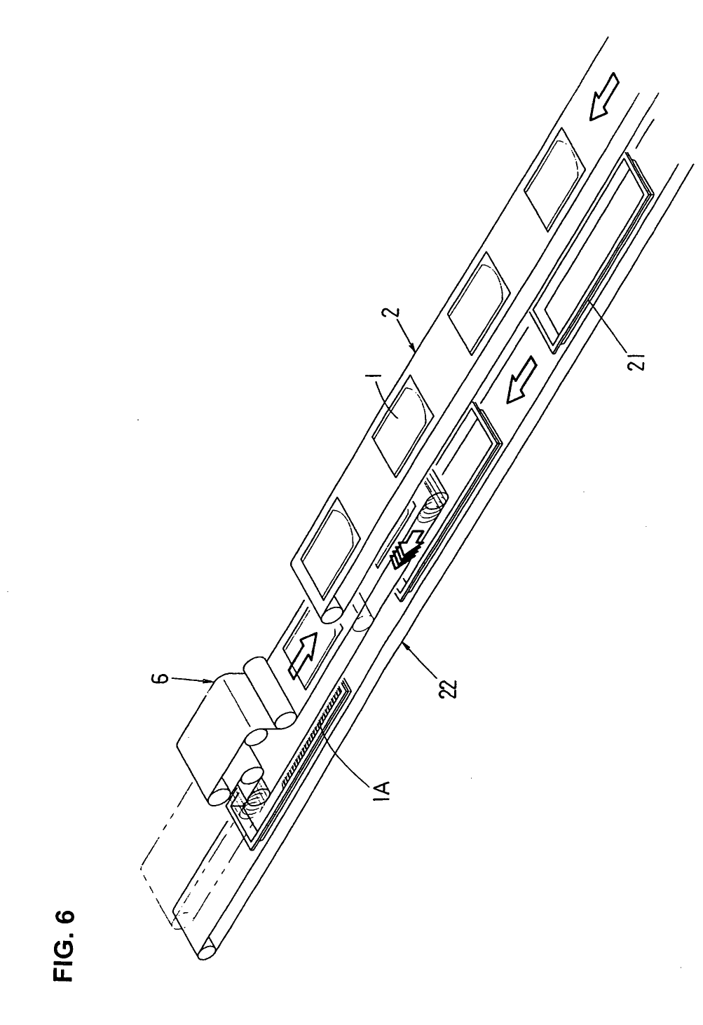

FIG. 6 shows another apparatus for supplying empty-bag group of the present invention (members that are substantially the same as in the apparatus for supplying empty-bag group shown in FIG. 1 are labeled with the same symbols).

This apparatus for supplying empty-bag group, in cases where a bag-making machine and a bag filling packaging machine are not connected, is disposed on the downstream side of the bag-making machine, and it stacks the empty bags 1, which are manufactured by the bag-making machine, placed on the belt conveyor 2, and conveyed one bag at a time at equal intervals, on the stacking tray 21, so that an empty-bag group 1A is formed. This empty-bag group 1A is conveyed to the vicinity of the bag filling packaging machine together with the stacking tray and is supplied to the conveyor magazine type bag supply apparatus of this bag filling packaging machine.

This apparatus for supplying empty-bag group shown in FIG. 6 comprises a belt conveyor 2 (an empty-bag supply means referred to in the present invention), a slide conveyor 6 which is disposed parallel to this belt conveyor 2 in a position beneath the belt conveyor 2, a belt conveyor 22 which is disposed in a position beneath the slide conveyor 6, and a stacking tray 21 which is disposed on the belt conveyor 22.

This apparatus of FIG. 6 differs from the apparatus shown in FIG. 1 in that the empty bags 1 that are released from the slide conveyor 6 are stacked not on the stacking conveyor 7, but rather on the stacking tray 21. The operations of the belt conveyor 2 and slide conveyor 6 are the same as in the apparatus for supplying empty-bag group shown in FIG. 1. Furthermore, like the stacking conveyor 7 of the apparatus shown in FIG. 1, the belt conveyor 22 stops during the stacking of the empty bags 1, so that the stacking tray 21 is positioned in the stacking position (position where the dropping empty bags 1 are stacked) beneath the slide conveyor 6.

When an empty-bag group 1A is formed by stacking a specified number of empty bags 1 on the stacking tray 21, the belt conveyor 22 is immediately driven in a conveying operation for a specified distance (a length of +α in the conveying direction of the stacking tray 21), so that the empty-bag group 1A is conveyed forward together with the stacking tray 21. A plurality of the same stacking trays 21 are carried on the belt conveyor 22 at equal intervals corresponding to the length +α in the conveying direction of these stacking trays 21; successive stacking trays 21 are conveyed forward, stopped in the above-described stacking position, and used for the stacking of empty bags 1. Meanwhile, the front end position of the slide conveyor 6 returns to the initial position (the position where the lowermost empty bag 1 of the empty-bag group 1A is released, i.e., the position where intermediate movement is started). Then, the intermediate movement of the slide conveyor 6 is again initiated, so that empty bags 1 are stacked on the stacking tray 21.

In the above-described apparatus for supplying empty-bag group shown in FIG. 6, the belt conveyor 22 (stacking trays 21) is stopped during the stacking of the empty-bag group 1A, and only the slide conveyor 6 is driven in a conveying operation, so that the front end position of this conveyor is caused to move intermittently toward the bag mouths (rearward) a specified distance at a time at a specified pitch. However, as in the case of the apparatus shown in FIG. 1, it is also possible (a) to cause the slide conveyor 6 to move continuously at a specified speed, (b) to cause the stacking trays 21 to move toward the bag bottoms side by means of the belt conveyor 22 during the stacking of the empty-bag group 1A, (c) to cause the stacking trays 21 to move toward the bag mouths side by means of the belt conveyor 22 during the stacking of the empty-bag group 1A, or (d) to use an ordinary belt conveyor instead of the slide conveyor 6, and to cause this belt conveyor as a whole to move toward the bag mouths side either continuously at a specified speed or intermittently at a specified pitch.

The stopper 9 and empty-bag holding device 12 described above can also be installed on the belt conveyor 2 or slide conveyor 6.

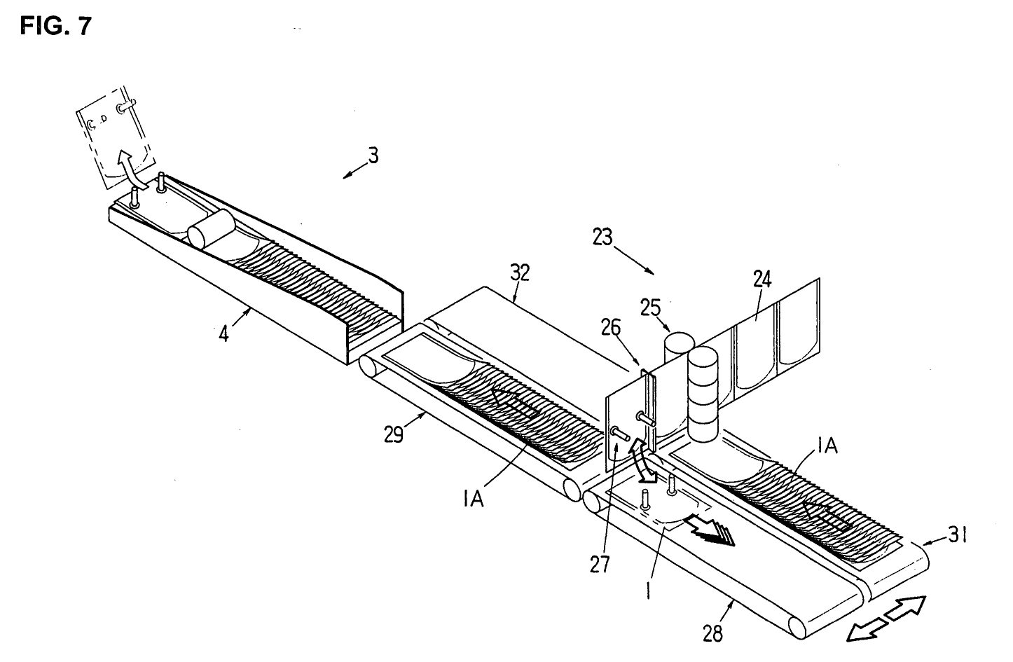

FIG. 7 shows another apparatus for supplying empty-bag group of the present invention. This apparatus for supplying empty-bag group is applied to a bag-making and packaging machine in which a bag filling packaging machine is installed on the downstream side of a bag-making machine.

The apparatus of FIG. 7 supplies empty bags 1 that are manufactured by the bag-making machine 23 and separated into individual bags to the conveyor magazine type bag supply apparatus (only a part of which is shown, as in FIG. 1) of the bag filling packaging machine. As to the bag-making machine 23, the main body of this machine is not shown in FIG. 7; and only the film 24 that is made into bags, the film feeding rollers 25 that intermittently feed this film 24, and the film cutting apparatus 26 that cuts this film 24 in order to separate the film into individual empty bags 1, are shown.

This apparatus for supplying empty-bag group in FIG. 7 comprises an empty-bag supply means 27 which suction-chucks the empty bags 1 that have been separated into individual bags by the film cutting apparatus 26 (only the suction disk that suction-chucks the empty bags and raises and lowers these empty bags is shown), a stacking conveyor 28 which is disposed in a position beneath the empty-bag supply means 27, a second conveyor 29 which is disposed in series in front of the stacking conveyor 28, and an identical stacking conveyor 31 and second conveyor 32 which are disposed in parallel with the stacking conveyor 28 and second conveyor 29. The stacking conveyors 28 and 31 can rotate in the forward and reverse directions.

The stacking conveyors 28 and 31 and second conveyors 29 and 32 can move together in the horizontal direction perpendicular to the conveying direction and are alternately positioned in first and second positions that are separated by a specified distance. FIG. 7 shows the state that exists in a case where the stacking conveyors 28 and 31 and second conveyors 29 and 32 are positioned in the first position. In this first position, the stacking conveyor 28 is in the empty-bag receiving position, and the second conveyor 29 is connected in series to the rear of the conveyor 4 of the conveyor magazine type bag supply apparatus 3. In the second position, the stacking conveyor 31 has arrived in the empty-bag receiving position, and the second conveyor 32 is connected in series to the rear of the conveyor 4.

In the above apparatus, the empty-bag supply means 27 supplies empty bags 1 manufactured by the bag-making machine 23 to a set position on the stacking conveyor 28 one at a time at a specified pitch, so that the direction of length of the empty bags 1 is set to be parallel to the conveying direction of the stacking conveyor 28, and so that the bottoms of the bags face forward. Meanwhile, the stacking conveyor 28 is caused to make a conveying operation toward the bottoms of the bags intermittently for a specified distance at a time at the above-described pitch (each time that an empty bag 1 is received). Accordingly, an empty-bag group 1A in which a specified number of empty bags are stacked with the upper bags being successively shifted a specified distance each in the direction of the bag mouths (i.e., a distance equal to the conveying distance of one conveying movement of the stacking conveyor 28) is formed on the stacking conveyor 28.

Instead of causing the stacking conveyor 28 to make a conveying operation intermittently for a specified distance at a time, it is also possible to cause this stacking conveyor 28 to make a continuous conveying operation at a specified speed. If the connection with the second conveyor 29 is not taken into consideration, then it is also possible to design the stacking conveyor 28 as a whole to move continuously at a specified speed or intermittently by a specified distance at a time.

While empty bags 1 are being stacked on the stacking conveyor 28, the empty-bag group 1A formed on the stacking conveyor 31 is conveyed onto the second conveyor 32. Furthermore, the empty-bag group 1A that has already been conveyed onto the second conveyor 29 is supplied to the conveyor 4 of the conveyor magazine type bag supply apparatus 3.

When an empty-bag group 1A in which a specified number of empty bags 1 are stacked is formed on the stacking conveyor 28, the conveying operation of the stacking conveyor 28 is stopped, and the stacking conveyors 28 and 31 and second conveyors 29 and 32 move together so that these conveyors are positioned in the second position. Here, the second conveyor 32 is connected in series with the conveyor 4.

Then, the stacking of empty bags 1 on the stacking conveyor 3, the conveying of an empty-bag group 1A from the stacking conveyor 28 to the second conveyor 29 and the supply of an empty-bag group 1A to the conveyor 4 from the second conveyor 32 are performed.

In the above-described apparatus for supplying empty-bag group, a separate belt conveyor can be disposed between the belt conveyor 4 and the second conveyors 29 and 32. In addition, it can be designed so that an empty-bag holding device equipped with shutter members similar to those of the previously described empty-bag holding device 12 is disposed in the empty-bag supply means 27, and an empty bag 1 that is released from the suction disk of the empty-bag supply means 27 is released (allowed to drop) onto the stacking conveyor 28 or stacking conveyor 31 via the empty-bag holding device. In this case, the shutter members of the empty-bag holding device need not be inclined.

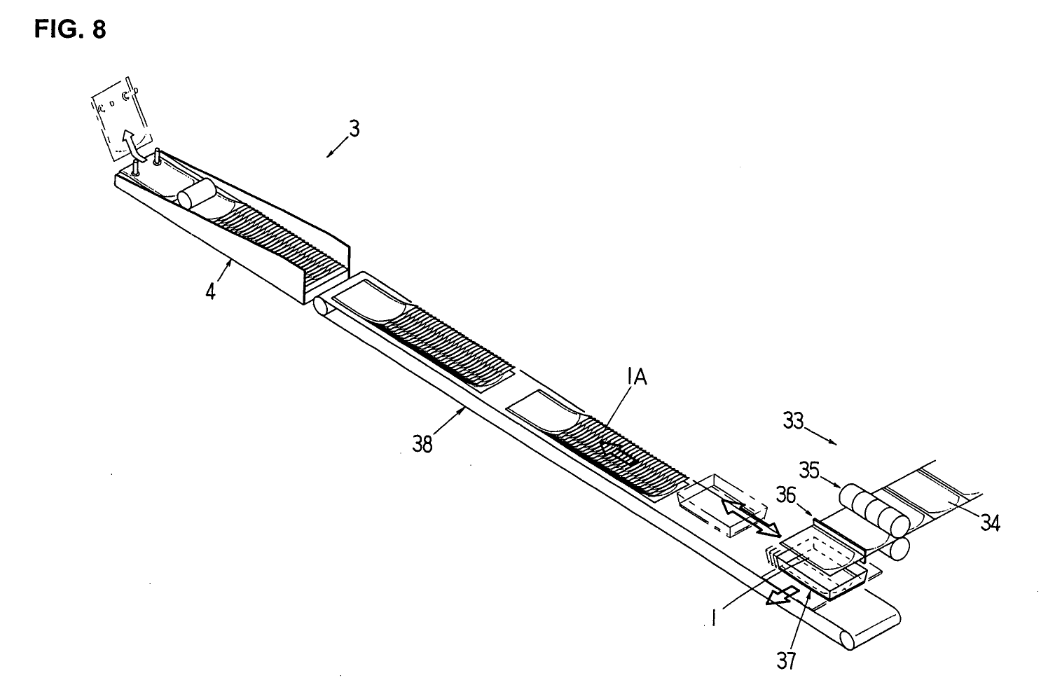

FIG. 8 shows another apparatus for supplying empty-bag group of the present invention. This apparatus for supplying empty-bag group is applied to a bag making and packaging machine in which a bag filling packaging machine is installed on the downstream side of a bag-making machine 33

The apparatus of FIG. 8 supplies empty bags 1 that have been manufactured by the bag-making machine 33 and separated into individual bags to the conveyor magazine type bag supply apparatus 3 (as in FIG. 1, only a part of this apparatus is shown in the figures) of the bag filling packaging machine. As to the bag-making machine, the main body of this machine is not shown in FIG. 8; and only the film 34 that is made into bags, the film feeding rollers 35 that intermittently feed this film, and the film cutting apparatus 36 that cuts the film 34 so that the film is separated into individual,empty bags 1, are shown.

The apparatus for supplying empty-bag group of FIG. 8 comprises an empty-bag holding device 37 that can receive, hold and release each one of the empty bags 1 that are separated into individual bags by the film cutting apparatus 36, and a stacking conveyor 38 which is disposed in a position beneath this empty-bag holding device 37. The film cutting apparatus 36 of the bag-making machine 33 functions as an empty-bag supply means in this apparatus.

The empty-bag holding device 37 can make a reciprocating motion parallel to the direction of length of the empty bags by a driving means not shown in FIG. 8 and is alternately positioned in a fixed initial position (a position directly beneath the film cutting apparatus 36) and a reciprocating position. The reciprocating position when operation is performed the first time is the same as the initial position (i.e., does not move); subsequently, however, this position is shifted toward the bag mouth side by a specified distance with each reciprocating motion. The empty-bag holding device 37 as a whole has a box shape; however, the bottom wall is a shutter wall that can be opened and closed on the left and right by an opening and closing means not shown in FIG. 8 (the open state is indicated by the imaginary lines in FIG. 8).

The stacking conveyor 38 is disposed so that the conveying direction of this conveyor is set to be parallel to the movement direction of the empty-bag holding device 37.

When the empty-bag holding device 37 is in the initial position with the shutter wall in a closed state, empty bags 1 are supplied one at a time at a specified pitch from the film cutting apparatus 36.

The empty-bag holding device 37 moves to the reciprocating position with the empty bags held inside; here, the shutter wall is opened, and the empty bags 1 inside are released onto the stacking conveyor 38.

Then, the empty-bag holding device 37 returns to the initial position, the shutter wall is closed, and the above action is repeated.

With each reciprocating movement, the next reciprocating position is shifted by a specified distance toward-the bag mouths (i.e., becomes more distant by a specified distance at a time in FIG. 8). Meanwhile, the stacking conveyor 38 is stopped until the number of empty bags that are released from the empty-bag holding device 37 reaches a specified number of bags. Accordingly, the empty bags 1 are stacked on the stacking conveyor 38 with the upper empty bags being successively shifted by a specified distance at a time toward the bag mouths.

When the number of stacked empty bags 1 reaches a specified number of bags so that an empty-bag group 1A is formed, the stacking conveyor 38 is immediately caused to make a conveying operation by a specified distance (length +α in the conveying direction of the empty-bag group 1A), so that the empty-bag group 1A on the stacking conveyor 38 is fed forward. In this case, the foremost empty-bag group 1A on the stacking conveyor 38 is supplied to the belt conveyor 4 of the conveyor magazine type bag supply apparatus 3.

Then, the empty-bag holding device 37 again repeats a reciprocating motion for the same specified number of times as before, beginning from the first reciprocating motion in which the reciprocating position is also the initial position.

Furthermore, in the above-described apparatus of FIG. 8, the stacking conveyor 38 is stopped during the stacking of the empty-bag group 1A, and only the empty-bag holding device 37 is moved; and the reciprocating position is caused to move toward the bag mouths by a specified distance at a time with each reciprocating movement. However, as in the case of the apparatus shown in FIG. 1, it is also possible to devise the stacking conveyor 38 so that forward and reverse rotation are possible and to drive the stacking conveyor 38 in a conveying operation toward the bag bottoms during the stacking of the empty-bag group 1A. Alternatively, it is also possible to drive the stacking conveyor 38 in a conveying operation toward the bag bottoms during the stacking of the empty-bag group 1A. Furthermore, in the above apparatus for supplying empty-bag group, a separate belt conveyor may also be disposed between the belt conveyor 4 and the stacking conveyor 38.

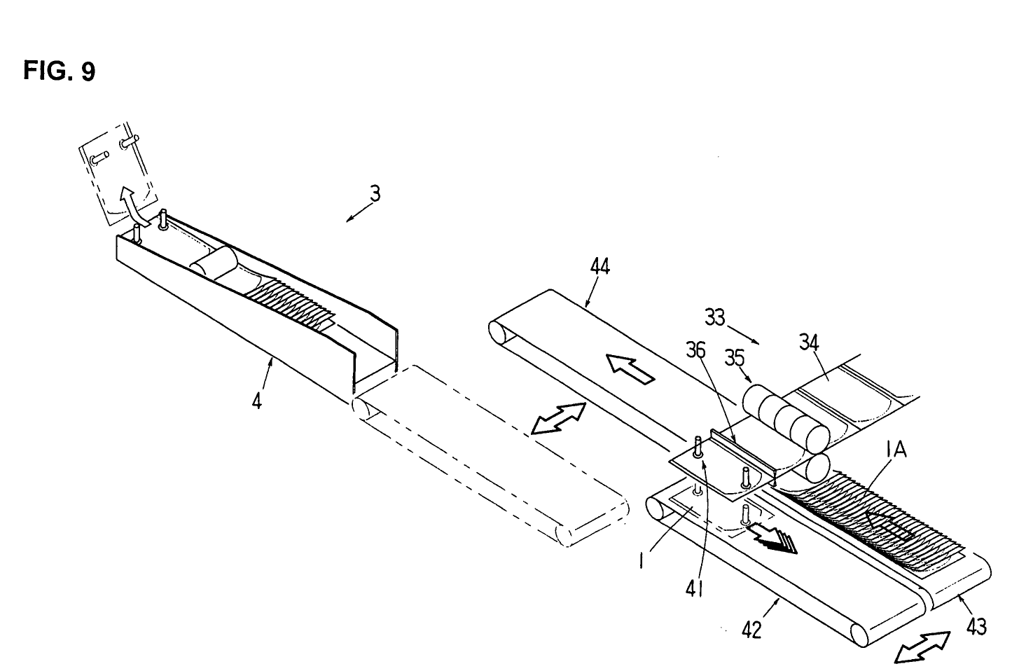

FIG. 9 shows another apparatus for supplying empty-bag group of the present invention. This apparatus for supplying empty-bag group is applied to a bag making and packaging machine in which a bag filling packaging machine is installed on the downstream side of a bag-making machine 33.

The apparatus of FIG. 9 supplies empty bags 1 that have been manufactured by the bag-making machine 33 and separated into individual bags to a conveyor magazine type bag supply apparatus 3 (as in FIG. 1, only a part of this apparatus is shown FIG. 9) of the bag filling packaging machine. As to the bag-making machine, the main body of this machine is not shown in FIG. 9; and only the film 34 that is made into bags, the film feeding rollers 35 that intermittently feed this film, and the film cutting apparatus 36 that cuts the film 34 so that the film is separated into individual empty bags 1, are shown.

This apparatus for supplying empty-bag group of FIG. 9 comprises an empty-bag group supply means 41 which suction-chucks the empty bags 1 separated into individual bags by the film cutting apparatus 36, conveys these empty bags downward and releases the empty bags (only the suction disk that suction-chucks the empty bags and raises and lowers these bags is shown), a pair of stacking conveyors 42 and 43 which are disposed side by side in positions beneath the empty-bag group supply means 41, and a second conveyor 44 which is disposed between the stacking conveyors 42 and 43 and the belt conveyor 4 of the conveyor magazine type bag supply apparatus 3 and whose conveying direction is oriented parallel to the stacking conveyors 42 and 43.

The stacking conveyors 42 and 43 are capable of making forward and reverse rotation and are set so that these conveyors can make a reciprocating motion together in the horizontal plane perpendicular to the conveying direction. As a result of this reciprocating motion, the stacking conveyors 42 and 43 are alternately positioned in the receiving position for the empty bags 1; and when one of the stacking conveyors is in the above-described receiving position, the other stacking conveyor is in a non-receiving position on the left or right. In FIG. 9, the stacking conveyor 42 is positioned in the receiving position, and the stacking conveyor 43 is positioned in the non-receiving position.

The second conveyor 44 alternately receives empty-bag groups 1A from the pair of stacking conveyors 42 and 43 and supplies these empty-bag groups 1A to the belt conveyor 4. This second conveyor 44 can make a reciprocating motion in the horizontal plane perpendicular to the conveying direction and is alternately positioned (as a result of this reciprocating motion) in a position located in front of the stacking conveyor that is in the non-receiving position (see the solid line and imaginary line in FIG. 9; the position indicated by the solid line is the first position, and the position indicated by the imaginary line is the second position). When the stacking conveyors 42 and 43 are moved leftward from the positions shown FIG. 9 so that the stacking conveyor 42 is positioned in the non-receiving position, the second conveyor 44 that is positioned in the forward position (second position) is simultaneously connected in series to the rear end of the belt conveyor 4. The movement distance through which the second conveyor moves from the first position to the second position is set as double of the movement distance of the stacking conveyors 42 and 43.

An example of the operation of this apparatus for supplying empty-bag group of FIG. 9 is described as follows:

(1) The empty-bag supply means 41 supplies empty bags 1 that have been manufactured by the bag-making machine to a specified position on the stacking conveyor 42 one bag at a time at a specified pitch, so that the direction of length of the empty bags 1 is set to be parallel to the conveying direction of the stacking conveyor 42, and so that the bottoms of the bags face forward. Meanwhile, the stacking conveyor 42 is caused to make a conveying operation toward the bottoms of the bags in an intermittent manner by a specified distance at a time at the above-described pitch (each time that one empty bag 1 is received). Accordingly, an empty-bag group 1A in which a specified number of empty bags are stacked with the upper bags being shifted by a specified distance at a time (a distance that is the same as the conveying distance of a single conveying movement of the stacking conveyor 42) is formed on the stacking conveyor 42. Furthermore, instead of causing the stacking conveyor 42 to make a conveying operation in an intermittent manner by a specified distance at a time, it is also possible to cause this stacking conveyor 42 to make a conveying operation in a continuous manner at a specified speed.

On the stacking conveyor 43 side, the second conveyor 44 that is positioned in the first position is connected in series to the front of the stacking conveyor 43.

(2) The stacking conveyor 43 and second conveyor 44 make a conveying operation, so that the empty-bag group 1A that is formed on the stacking conveyor 43 is fed forward and is transferred onto the second conveyor 44.

(3) The second conveyor 44 moves horizontally and is positioned in the second position; then, a conveying operation is performed so that the empty-bag group 1A is fed forward, and is transferred onto the belt conveyor 4. An empty-bag group 1A comprising a specified number of empty bags 1 is formed on the stacking conveyor 42.

(4) The stacking conveyors 42 and 43 move horizontally, so that the stacking conveyor 43 is positioned in the receiving position, and the stacking conveyor 42 is positioned to the rear of the second conveyor 44. Then, empty bags 1 are stacked on the stacking conveyor 43 (the conveying operation of the stacking conveyor 43 in this case is the same as the conveying operation of the stacking conveyor 42 described above); and the stacking conveyor 42 and second conveyor 44 make a conveying operation, so that the empty-bag group 1A that is formed on the stacking conveyor 42 is fed forward and is transferred onto the second conveyor 44.

(5) The second conveyor 44 makes a conveying operation, so that the empty-bag group 1A is fed forward and transferred onto the belt conveyor 4. Then, the second conveyor 44 moves horizontally and is positioned in the first position.

(6) When an empty-bag group 1A is formed on the stacking conveyor 43, the stacking conveyors 42 and 43 move horizontally, so that the stacking conveyor 42 is positioned in the receiving position.

(7) The above process is repeated.

In the above-described example, the empty-bag supply means 41 that uses a suction disk is used as a means for feeding empty bags 1 onto the stacking conveyors 42 and 43. Instead of this, however, it is also possible to use an empty-bag (stacked-assembly) supply means such as the slide conveyor 6 shown in FIG. 1, the empty-bag holding device 37 shown in FIG. 8, an empty-bag stacking device 53 (described later) or the like. In this case, it is sufficient if the stacking conveyors 42 and 43 make a conveying operation corresponding to the respective empty-bag (stacked-assembly) supply means. Furthermore, in the above-described example, empty-bag groups 1A are fed with the second conveyor 44 and the belt conveyor 4 of the conveyor magazine type bag supply apparatus 3 directly connected. However, it is also possible, for example, to interpose another belt conveyor between the second conveyor 44 and belt conveyor 4 as a type of buffer (storage device).

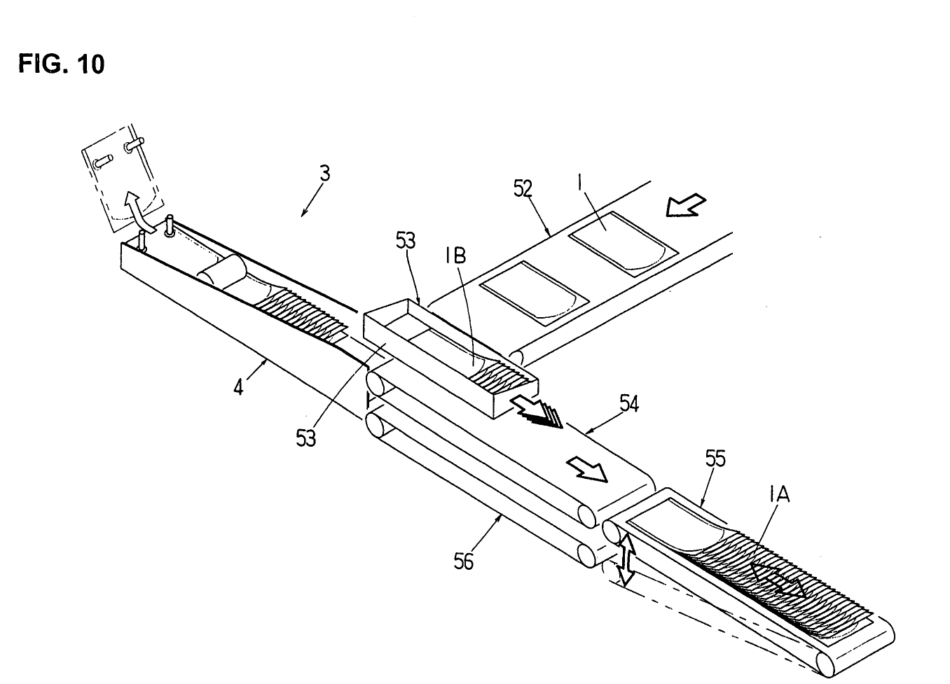

FIG. 10 shows another apparatus for supplying empty-bag group of the present invention. This apparatus for supplying empty-bag group is applied to a bag making and packaging machine in which a bag filling packaging machine is installed on the downstream side of a bag-making machine.

The apparatus of FIG. 10 supplies empty bags 1, which are manufactured by the bag-making machine (not shown in FIG. 10), placed on a belt conveyor 52, and conveyed one bag at a time at equal intervals, to the conveyor magazine type bag supply apparatus 3 of the bag filling packaging machine (as in FIG. 1, only a part of this apparatus is shown in FIG. 10).

This apparatus for supplying empty-bag-group of FIG. 10 comprises a belt conveyor 52 (an empty-bag supply means referred to in the present invention), an empty-bag stacking device 53 which receives empty bags 1 from the belt conveyor 52 stacks a specified number of these empty bags and releases the stacked assembly 1B thus obtained downward, a stacking conveyor 54 which is disposed in a position beneath the empty-bag stacking device 53, a rising-and-lowering conveyor 55 which is disposed in front of the stacking conveyor 54, and a second conveyor 56 which is disposed between the rising-and-lowering conveyor 55 and the belt conveyor 4 of the conveyor magazine type bag supply apparatus 3 so as to be beneath the stacking conveyor 54.

The empty-bag stacking device 53 overall has a box-form shape. One side wall 53a of this empty-bag stacking device 53 (the side wall on the far side from the belt conveyor 52) functions as a positioning stopper for the empty bags 1 that are supplied from the belt conveyor 52, and the bottom wall is slightly inclined on the side of the side wall 53a and constitutes a shutter wall that can be opened and closed in the left-right direction by an opening and closing means not shown in FIG. 10 (in regard to this shutter wall, see the empty-bag holding device 37 shown in FIG. 8).

Furthermore, the empty-bag stacking device 53 can make a reciprocating motion parallel to the direction of length of the empty bags by a driving means not shown in FIG. 10; and when empty bags 1 that are supplied one bag at a time at a specified pitch from the belt conveyor 52 are received, the empty-bag stacking device 53 moves toward the bottoms of the bags either continuously at a specified speed, or intermittently by a specified distance at a time at the above-described pitch. Accordingly, when empty bags 1 are supplied one bag at a time to the empty-bag stacking device 53 from the belt conveyor 52, these empty bags 1 contact the inside surface of the side wall 53a and drop downward, so that these empty bags 1 are stacked along the side wall 53a inside the empty-bag stacking device 53 with the upper bags successively shifted a specified distance at a time toward the mouths of the bags.

When a predetermined number of empty bags 1 have been stacked inside the empty-bag stacking device 53 (i.e., when a stacked assembly 1B has been formed), the shutter wall that is previously closed is opened, so that the stacked assembly 1B is released downward. The shutter wall is closed next, and the empty-bag stacking device 53 is returned to its original position. The supply of empty bags 1 to the returned empty-bag stacking device 53 is continued.

The stacking conveyor 54 is caused to make a conveying operation each time that a stacked assembly 1B is released from the empty-bag stacking device 53. In this case, the conveying distance of the above-described conveying operation is set so that the stacked assemblies 1B are stacked on the stacking conveyor 54 with the lowermost bag of the stacked assembly 1B that is received next shifted by the above-described specified distance toward the bag mouths with respect to the uppermost bag of the stacked assembly 1B that is received previously. More specifically, the conveying distance of one conveying movement of the stacking conveyor 54 is set at n×S, where n is the number of empty bags 1 forming the stacked assembly 1B, and S is the above-described specified distance. However, in cases where a plurality of stacked assemblies 1B are stacked on the stacking conveyor 54 so that an empty-bag group 1A comprising a specified number of empty bags 1 is formed, the stacking conveyor 54 is caused to make a conveying operation until the empty-bag group 1A in question has been completely fed onto the subsequent rising-and-lowering conveyor 55.

Furthermore, if the above-described numerical value n is too large, the moving distance of the empty-bag stacking device 53 is lengthened; accordingly, after the empty-bag stacking device 53 receives the nth empty bag 1, considerable time is required until the empty-bag stacking device 53 releases the stacked assembly 1B and returns to its original position. Consequently, in cases where the supply pitch of the empty bags 1 from the belt conveyor 52 is rapid, the return of the empty-bag stacking device 53 is not completed in time to receive the next empty bag 1.

On the other hand, if the above-described numerical value n is too small, the time intervals at which the empty-bag stacking device 53 releases the stacked assemblies 1B is shortened, so that the time required by the stacking conveyor 54 in order to feed the empty-bag groups 1A onto the rising-and-lowering conveyor 55 cannot be sufficiently obtained.

The above-described numerical value n is thus appropriately set with the facts described above taken into account.

The above-described rising-and-lowering conveyor 55 can make forward and reverse conveying operations, and it is disposed so that that this conveyor can be caused to swing upward and downward, as shown by the vertical arrow, about the end portion that is on the opposite end from the stacking conveyor 54. As a result of this swing motion, the end portion of the rising-and-lowering conveyor 55 on the stacking conveyor 54 side is raised and lowered. In the ascended position, the conveyor 55 is at the same height as the stacking conveyor 54, so that the conveyor 55 can receive empty-bag groups 1A from this stacking conveyor 54. In the descended position, the conveyor 55 is lower than the stacking conveyor 54 and is at the same height as the second conveyor 56, so that the conveyor 55 can feed empty-bag groups 1A to the second conveyor 56. The second conveyor 56 is connected in series to the rear portion of the belt conveyor 4.

In the above-described operation, empty-bag groups 1A are formed on the stacking conveyor 54 by releasing the stacked assemblies 1B of empty bags from the empty-bag stacking device 53. Instead of this, however, it is also possible to use an empty-bag supply means such as the slide conveyor 6 shown in FIG. 1, the empty-bag supply means 27 that uses a suction disk shown in FIG. 7, the empty-bag holding device 37 shown in FIG. 8 or the like. In this case, it is sufficient if the stacking conveyor 54 makes a conveying operation corresponding to the respective empty-bag supply means.

Furthermore, in the above-described structure, the second conveyor 56 is interposed between the rising-and-lowering conveyor 55 and the belt conveyor 4. However, it is also possible to eliminate the second conveyor 56 and to design so that the lowered rising-and-lowering conveyor 55 is directly connected to the rear portion of the belt conveyor 4. In this case, the belt conveyor 4 is positioned beneath the stacking conveyor 54.

In addition, in the above-described structure, the rising-and-lowering conveyor 55 is caused to swing so that the portion located on the stacking conveyor 54 side is raised and lowered. However, it is also possible to design so that the rising-and-lowering conveyor 55 as a whole is raised and lowered in a horizontal attitude.

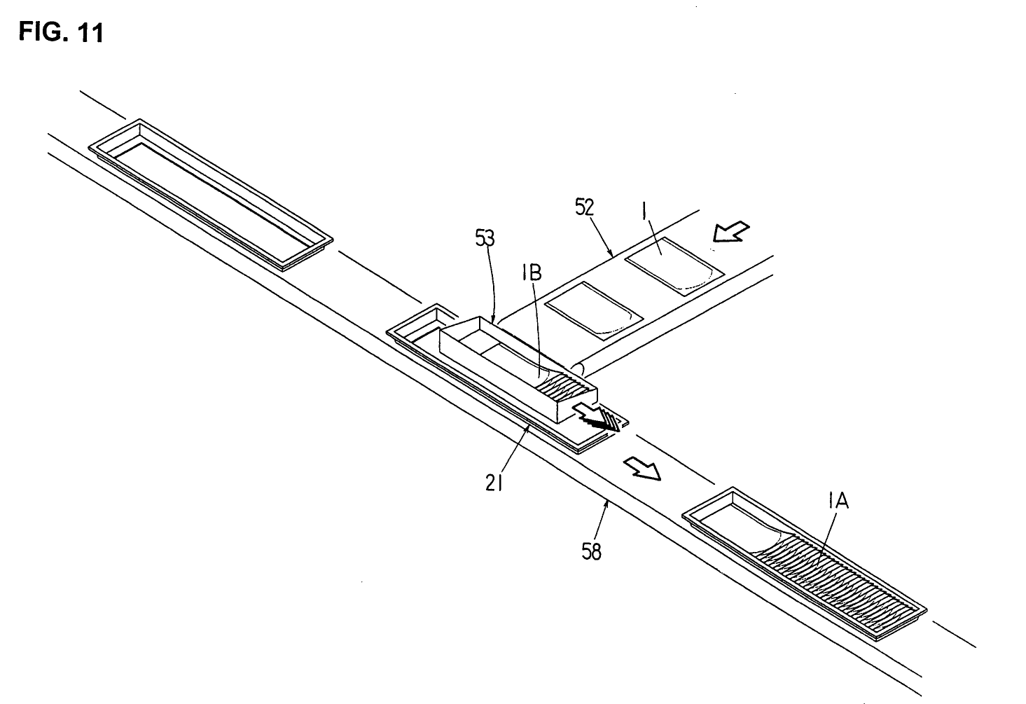

FIG. 11 shows another apparatus for supplying empty-bag group of the present invention (here, members that are substantially the same as in the apparatus for supplying empty-bag group shown in FIG. 10 are labeled with the same numbers). This apparatus for supplying empty-bag group is disposed on the downstream side of the above-described bag-making machine in cases where the bag-making machine and the bag filling packaging machine are not connected.

The apparatus of FIG. 11 forms an empty-bag group 1A by stacking empty bags 1, which are manufactured by the bag-making machine, placed on the belt conveyor 52 and conveyed one bag at a time at equal intervals, on a stacking tray 21. This empty-bag group 1A is conveyed to the vicinity of the bag filling packaging machine together with the stacking tray, and is supplied to the conveyor magazine type bag supply apparatus of the bag filling packaging machine.

The apparatus for supplying empty-bag group shown in FIG. 11 comprises a belt conveyor 52, an empty-bag stacking device 53 which can receive empty bags 1 from the belt conveyor 52, stack a specified number of these empty bags, and release the stacked assembly 1B thus obtained downward, a belt conveyor 58 which is disposed in a position beneath this empty-bag stacking device 53, and a stacking tray 21 which is carried on the belt conveyor 58.

The above apparatus for supplying empty-bag group of FIG. 11 differs from the apparatus shown in FIG. 10 in that the stacked assemblies 1B released from the empty-bag stacking device 53 are stacked on a stacking tray 21 instead of being stacked on the stacking conveyor 54. The operation of the belt conveyor 52 and empty-bag stacking device 53 is the same as that in the apparatus of FIG. 1. The belt conveyor 58 is caused to make a conveying operation in the same manner as the stacking conveyor 54 of the apparatus for supplying empty-bag group shown in FIG. 10.

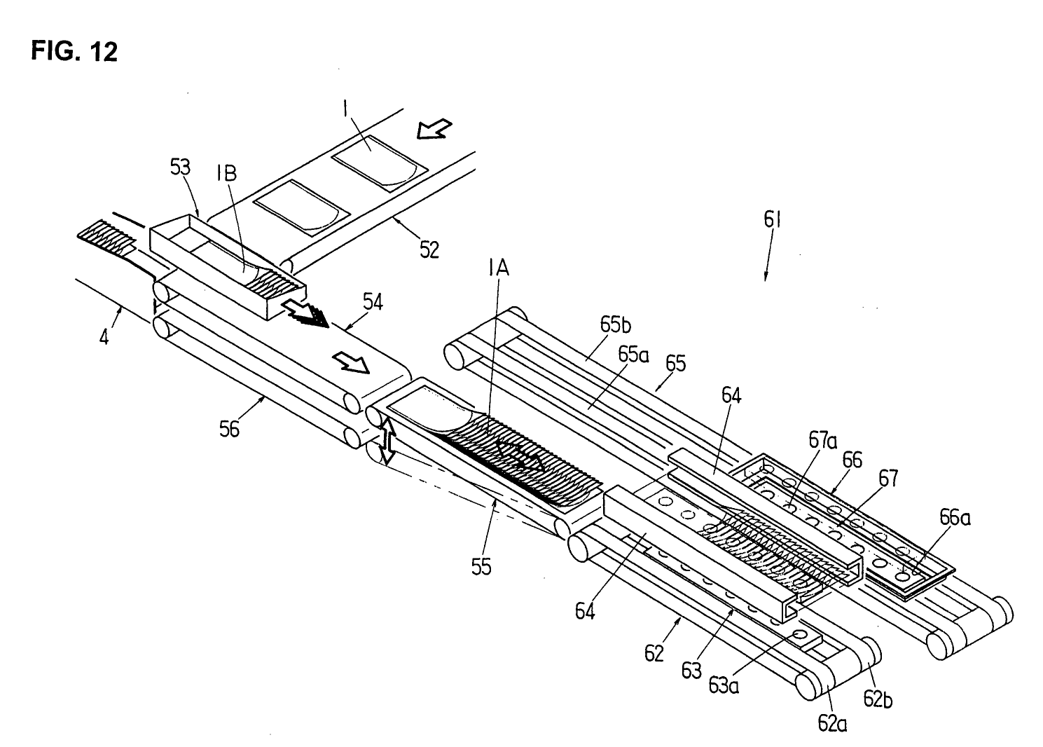

FIG. 12 shows another apparatus for supplying empty-bag group of the present invention (here, members that are substantially the same as in the apparatus for supplying empty-bag group shown in FIG. 10 are labeled with the same numbers). In this apparatus for supplying empty-bag group, an empty-bag group accommodating device 61 that is actuated in cases where, for example, the bag filling packaging machine temporarily stops so that the consumption of empty bags 1 is suspended is added to the apparatus shown in FIG. 10.

The empty-bag group accommodating device 61 is devised so that an empty-bag group 1A carried on the belt conveyor is supported from below and lifted by an extraction member, the lifted empty-bag group 1A is held by a holding member and transferred to a position above the stacking tray, a receiving member is caused to protrude upward through a hole formed in the bottom wall of the stacking tray, the empty-bag group 1A is supported from below by this receiving member, and the receiving member is then lowered and removed in the downward direction from the stacking tray so that the empty-bag group 1A is left on the stacking tray.

The above-described extraction member is comprised of, for example, a suction-chucking body which has on its upper surface a suction-chucking part (vacuum suction hole) that suction-chucks the central portion of the undersurface of the empty-bag group. The suction-chucking body is raised and lowered so that it protrudes upward from below via a gap in the belt conveyor and is retracted downward.

The above-described holding member can hold, for instance, both side portions of the empty-bag group, and it makes a reciprocating motion between the position of the belt conveyor and the stacking tray.

The above-described receiving member is comprised of, for instance, a suction-chucking body which has on its upper surface a suction-chucking part (vacuum suction hole) that suction-chucks the central portion of the undersurface of the empty-bag group. The suction-chucking body is raised and lowered so that it protrudes upward from below through a hole formed in the bottom wall of the stacking tray and is retracted downward.

The above-described empty-bag group accommodating device 61 of FIG. 12 will be described more concretely.

As seen from FIG. 12, the empty-bag group accommodating device 61 comprises a belt conveyor 62 which is disposed as a continuation of the rising-and-lowering conveyor 55, an extraction member (suction-chucking body 63) which is disposed between the pair of conveyor belts 62a and 62b of the belt conveyor 62 and which can be raised and lowered through the space between these belts, a pair of holding members 64 which are disposed above the belt conveyor 62, a belt conveyor 65 which is disposed parallel to the belt conveyor 62 at the same height as this belt conveyor 62, a stacking tray 66 which is disposed above the belt conveyor 65, and a receiving member (suction-chucking body 67) which is disposed between the pair of conveyor belts 65a and 65b of the belt conveyor 65 and which can be raised and lowered via the space between these belts-and via a hole 66a formed in the bottom wall of the stacking tray 66.

The suction-chucking bodies 63 and 67 are box-form elements which have a length that is substantially equal to the total length of the empty-bag groups 1A. Suction holes 63a and 67a are formed in the horizontal upper surfaces of the suction-chucking bodies 63 and 67, and the interiors of the suction-chucking bodies 63 and 67 communicate with a vacuum source (not shown in FIG. 12) so that vacuum suction is applied. When the suction-chucking bodies 63 and 67 are raised so that the upper surfaces of these bodies contact the bottom surface of the empty-bag group 1A, the bottom surface is suction-chucked, and the central portion of the empty-bag group 1A can be stably supported.

The holding members 64 have a length that is substantially equal to the total length of the empty-bag groups 1A. The holding members 64 are able to approach each other and move away from each other in the lateral direction, and respectively hold the side portions of the empty-bag groups 1A.

This empty-bag group accommodating device 61 does not operate in cases where the bag filling packaging machine is operating normally, but it operates in cases where the bag filling packaging machine temporarily stops (so-called temporary stopping) while the bag-making machine continues to operate, or the like.

The operation of the empty-bag group accommodating device 61 is as follows.

(1) The rising-and-lowering conveyor 55 carrying thereon the empty-bag group 1A makes a conveying operation in the reverse direction from the ordinary direction, without being lowered. At the same time, the belt conveyor 62 makes a conveying operation in the same direction, so that the empty-bag group 1A is fed onto the belt conveyor 62 from the rising-and-lowering conveyor 55, and this empty-bag group 1A stops in a specified position on the belt conveyor 62.

(2) The suction-chucking body 63 is raised so as to come in contact with the central portion of the bottom surface of the empty-bag group 1A and suction-chucks this bottom surface. This empty-bag group 1A is thus supported from below and lifted from the belt conveyor 62, so that the empty-bag group 1A is positioned between the holding members 64.

(3) The holding members 64 approach each other so that the side portions of the empty-bag group 1A are held between upper and lower claws (see the imaginary lines). Then, the interior of the suction-chucking body 63 is restored to atmospheric pressure (end of suction-chucking), and the suction-chucking body 63 is lowered to its original position. Meanwhile, the holding members 64 move in the horizontal direction, so that the empty-bag group 1A held thereby is transported to a position above the belt conveyor 65. In a specified position on the belt conveyor 65, the stacking tray 66 is positioned.

(4) The suction-chucking body 67 is raised via the hole 66a in the stacking tray 66 (see imaginary line), so that the upper surface of the suction-chucking body 67 contacts and suction-chucks the central portion of the bottom surface of the empty-bag group 1A held by the holding members 64, thus supporting this empty-bag group 1A from below. Then, the holding members 64 are separated from each other, thus releasing the empty-bag group 1A.

(5) The suction-chucking body 67 is lowered, and the empty-bag group 1A is accommodated in the stacking tray 66. The interior of the suction-chucking body 67 is next restored to atmospheric pressure (end of suction chucking), and the suction-chucking body 67 is lowered to a position beneath the stacking tray 66. During this period, the holding members 64 move horizontally and return to their original positions (positions indicated by the solid lines in FIG. 12).

(6) The belt conveyor 65 is caused to make a conveying operation, so that the stacking tray 66 accommodating the empty-bag group 1A is conveyed to the next position. Furthermore, the stacking tray 66 is again positioned in a specified position on the belt conveyor 65, so that the next empty-bag group 1A is supplied for accommodation. The empty-bag group 1A accommodated in the stacking tray 66 is stored together with the stacking tray and is supplied to the belt conveyor 4 when, for example, the bag filling packaging machine is newly operated. In this case, initiation of the operation of the bag-making machine may be delayed until the stored empty-bag groups 1A are exhausted.

In the structure of FIG. 12, in cases where the bag filling packaging machine is temporarily stopped so that the consumption of empty bags 1 is suspended while the operation of the bag-making machine is continued, the empty-bag group accommodating device 61 is actuated so that the empty-bag groups 1A are accommodated in stacking trays 66. However, in cases where an empty-bag group accommodating device 61 is not provided, as in the apparatus shown in FIG. 10, it is also possible to discharge empty-bag groups 1A from the end of the rising-and-lowering conveyor 55 (i.e., the end on the opposite side from the stacking conveyor 54). In this respect, a similar operation may be used in the apparatuses shown in FIGS. 1 and 7 through 9. Conversely, the empty-bag group accommodating device 61 may also be installed in the apparatus shown in FIGS. 1 and 7 through 9.

All of the apparatuses for supplying empty-bag groups described above (see FIG. 1 and FIGS. 7 through 10 and 12) are those that correspond to a single conveyor magazine type bag supply apparatus. However, in cases where the bag filling packaging machine is a W type machine (a bag filling packaging machine in which two bags are supplied at one time, and the same bag filling process is performed simultaneously for the two bags as described in, for example, Japanese Patent Application Laid-Open (Kokai) No. 2004-42447), then two conveyor magazine type bag supply apparatuses are required, and it is necessary to install respective apparatus for supplying empty-bag groups for the respective conveyor magazine type bag supply apparatuses.

1. A method for supplying empty-bag group, comprising the steps of:
feeding empty bags manufactured by a bag-making machine onto a stacking conveyor one at a time with a direction of length of bags oriented parallel to a conveying direction of said stacking conveyor, so that a specified number of bags are stacked on said stacking conveyor with upper bags being successively shifted by a specified distance at a time in the direction of length of bags so that said bags are shifted in a direction of bag mouths; and
conveying a resulting stacked empty-bag group by said stacking conveyor, thus supplying said empty-bag group to a conveyor magazine type bag supply apparatus of a bag filling packaging machine with bag mouth sides of the bags facing forward, either via another conveyor interposed or without another conveyor.

2. A method for supplying empty-bag group, comprising the steps of:
stacking empty bags manufactured by a bag-making machine in a specified number inside an empty-bag stacking device with upper bags being successively shifted by a specified distance at a time in a direction of length of bags so that said bags are shifted in a direction of bag mouths;
feeding a stacked assembly thus obtained onto a stacking conveyor with the direction of length of bags oriented parallel to a conveying direction of said stacking conveyor;
repeating said steps a plurality of times;
feeding a lowermost bag of a stacked assembly, which is fed next, with said bag being shifted by said specified distance in a direction of bag mouth with respect to an uppermost bag of a previously fed stacked assembly, so that an empty-bag group consisting of a plurality of stacked assemblies is stacked on said stacking conveyor; and
conveying said empty-bag group by said stacking conveyor, thus supplying said empty-bag group to a conveyor magazine type bag supply apparatus of a bag filling packaging machine with bag mouth sides of bags facing forward, either via another conveyor interposed or without another conveyor.

3. A method for supplying empty-bag group comprising the steps of:
feeding empty bags manufactured by a bag making machine one at a time into a stacking tray, so that these empty bags are stacked in a specified number on said tray with upper bags being successively shifted by a specified distance at a time in a direction of length of bags so that said bags are shifted in a direction of bag mouths;
conveying a resulting empty-bag group that is stacked inside said stacking tray together with said stacking tray;
removing the empty-bag group inside said stacking tray; and
sullying the empty-bag group to a conveyor magazine type bag supply apparatus of a bag filling packaging machine with bag mouth sides of the bags facing forward.

4. A method for supplying empty-bag group comprising the steps of:
stacking empty bags manufactured by a bag making machine in a specified number inside an empty-bag stacking device with upper bags being successively shifted by a specified distance at a time in a direction of length of bags so that said bags are shifted in a direction of bag mouths;
feeding a stacked assembly thus obtained onto a stacking tray with a direction of length of bags oriented parallel to a conveying direction of said stacking tray;
repeating said steps a plurality of times;
feeding a lowermost bag of a stacked assembly, which is fed next, with said bag being shifted by said specified distance in a direction of bag mouth with respect to an uppermost bag of a previously fed stacked assembly, so that an empty-bag group consisting of a plurality of stacked assemblies is stacked on said stacking tray;
conveying said empty-bag group together with said stacking tray;
removing the empty-bag group inside said stacking tray; and
supplying the empty-bag group to a conveyor magazine type bag supply apparatus of a bag filling packaging machine with bag mouth sides of bags facing forward.

5. An apparatus for supplying empty-bag group comprising:
a first conveyor which is driven in a conveying movement at a constant speed and conveys empty bags parallel to a direction of length of bags with bottom sides of bags facing forward and releases said bags from a front end thereof;
an empty-bag supply means which supplies empty bags manufactured by a bag making machine to said first conveyor one at a time at a specified pitch; and
a stacking conveyor which is provided beneath said first conveyor with a conveying direction of said stacking conveyor oriented parallel to that of said first conveyor, so that said stacking conveyor receives empty bags that are released from said first conveyor;
wherein
a front end position of said first conveyor can move back and forth along a conveying direction thereof; and
front end position of said first conveyor is caused to move toward bag mouths side either continuously or intermittently by a specified distance at a time at said specified pitch, thus forming an empty-bag group, in which a specified number of empty bags are stacked with upper bags successively shifted a specified distance at a time in a direction of bag mouths, on said stacking conveyor.

6. The apparatus for supplying empty-bag group according to claim 5, wherein said first conveyor is a slide conveyor with a front end thereof being slidable back and forth along said conveying direction intermittently and/or continuously.

7. The apparatus for supplying empty-bag group according to claim 5 or 6, wherein said stacking conveyor is connected to a rear portion of a conveyor of a conveyor magazine type bag supply apparatus of a bag filling packaging machine.

8. An apparatus for supplying empty-bag group comprising:
an empty-bag supply means which supplies empty bags manufactured by a bag making machine to a specified position one at a time at a specified pitch; and
a stacking conveyor which receives empty bags from said empty-bag supply means;
wherein
a conveying direction of said stacking conveyor is set to be parallel to a direction of length of said empty bags; and
said stacking conveyor is caused to make a conveying operation toward bottoms side of bags either continuously at a specified speed or intermittently by a specified distance at a time at said specified pitch, thus forming an empty-bag group, in which a specified number of empty bags are stacked with upper bags successively shifted a specified distance at a time in a direction of bag mouths, on said stacking conveyor.

9. The apparatus for supplying empty-bag group according to claim 8, wherein said stacking conveyor is connected to a rear portion of a conveyor of a conveyor magazine type bag supply apparatus of a bag filling packaging machine.

10. An apparatus for supplying empty-bag group comprising:
an empty-bag supply means which supplies empty bags manufactured by a bag making machine to a specified position one at a time at a specified pitch; and
a stacking conveyor which receives empty bags from said empty-bag supply means;
wherein
a conveying direction of said stacking conveyor is set to be parallel to a direction of length of said empty bags;
said stacking conveyor as a whole can move back and forth along said conveying direction; and
said stacking conveyor is caused to move as a whole toward bottoms side of bags either continuously at a specified speed or intermittently by a specified distance at a time at said specified pitch, thus forming an empty-bag group, in which a specified number of empty bags are stacked with upper bags successively shifted a specified distance at a time in a direction of bag mouths.

11. An apparatus for supplying empty-bag group comprising:
an empty-bag supply means which supplies empty bags manufactured by a bag making machine to a specified position one at a time at a specified pitch;
an empty-bag holding device which can make a reciprocating motion parallel to a direction of length of said empty bags, is alternately positioned in a fixed initial position and a reciprocating position, and has a shutter means that can be freely opened and closed, so that said empty-bag holding device accommodates and holds an empty bag when said shutter means is closed and releases an empty bag downward when said shutter means is opened; and
a stacking conveyor which is provided beneath said empty-bag holding device so that a conveying direction of said stacking conveyor is parallel to a movement direction of said empty-bag holding device and so that said stacking conveyor receives an empty bag that is released from said empty-bag holding device;
wherein said empty-bag holding device:
receives an empty bag from said empty-bag supply means in a state in which said shutter means is closed in said initial position;
then moves to said reciprocating position;
opens said shutter means in said reciprocating position and releases the empty bag onto said stacking conveyor; and
shifts said reciprocating position toward bag mouths side by a specified distance with each reciprocating motion;
thus forming an empty-bag group, in which a specified number of empty bags are stacked with upper bags successively shifted a specified distance at a time in a direction of bag mouths, on said stacking conveyor.

12. The apparatus for supplying empty-bag group according to claim 11, wherein said stacking conveyor is connected to a rear portion of a conveyor of a conveyor magazine type bag supply apparatus of a bag filling packaging machine.

13. An apparatus for supplying empty-bag group comprising:
an empty-bag supply means which supplies empty bags manufactured by a bag making machine to a specified position one at a time at a specified pitch;
an empty-bag stacking device which can make a reciprocating motion parallel to a direction of length of said empty bags, and has a shutter means that can be freely opened and closed, so that said empty-bag stacking device closes said shutter means to receive empty bags from said empty-bag supply means and stacks a specified number of said empty bags, and said empty-bag stacking device opens said shutter means to release a stacked assembly thus obtained downward; and
a stacking conveyor which is provided beneath said empty-bag stacking device so that a conveying direction of said stacking conveyor is parallel to a movement direction of said empty-bag stacking device, so that said stacking conveyor receives stacked assemblies released from said empty-bag stacking device and stacks an empty-bag group comprising a plurality of stacked assemblies;
wherein:
said empty-bag stacking device is caused to move toward bottoms side of bags either continuously at a constant speed or intermittently by a specified distance at a time at said specified pitch when empty bags are received from said empty-bag supply means, thus forming a stacked assembly of empty bags, in which a plurality of empty bags are stacked with upper bags being successively shifted a specified distance at a time toward bag mouths, inside said empty-bag stacking device; and
said stacking conveyor makes a conveying operation each time one of said stacked assemblies is received, and stacks said stacked assemblies on said stacking conveyor so that lowermost bag of a stacked assembly that is received next is shifted by a specified distance in a direction of bag mouth with respect to an uppermost bag of a stacked assembly received previously.

14. The apparatus for supplying empty-bag group according to claim 13, wherein said stacking conveyor is connected to a rear portion of a conveyor of a conveyor magazine type bag supply apparatus of a bag filling packaging machine.

15. The apparatus for supplying empty-bag group according to any one of claims 5, 6, 8 and 11, further comprising a second conveyor provided in front of said stacking conveyor so as to receive empty-bag groups from said stacking conveyor,
wherein
two sets each consisting of said stacking conveyor and second conveyor are disposed side by side;
said stacking and second conveyors are set so as to make a reciprocating motion together within a horizontal plane perpendicular to said conveying direction; and
said stacking conveyors are alternately positioned in an empty-bag receiving position as a result of said reciprocating motion.

16. The apparatus for supplying empty-bag group according to claim 13, further comprising a second conveyor provided in front of said stacking conveyor so as to receive empty bags from said stacking conveyor,
wherein
two sets each consisting of said stacking conveyor and second conveyor are disposed side by side;
said stacking and second conveyors are set so as to make a reciprocating motion together in a horizontal plane perpendicular to said conveying direction; and
said stacking conveyors are alternately positioned in a stacked assembly receiving position as a result of said reciprocating motion.

17. The apparatus for supplying empty-bag group according to claim 15, wherein a second conveyor, which belongs to the same set as a stacking conveyor positioned in the empty-bag receiving position as a result of said reciprocating motion of the set consisting of said stacking conveyor and second conveyor, is connected to the rear portion of the conveyor of the conveyor magazine type bag supply apparatus of a bag filling packaging machine.

18. The apparatus for supplying empty-bag group according to claim 16, wherein a second conveyor, which belongs to the same set as a stacking conveyor positioned in the stacked assembly receiving position as a result of said reciprocating motion of the set consisting of said stacking conveyor and second conveyor, is connected to the rear portion of the conveyor of the conveyor magazine type bag supply apparatus of a bag filling packaging machine.

19. The apparatus for supplying empty-bag group according to any one of claims 5, 6, 8 and 11,
wherein
a pair of said stacking conveyors are disposed side by side;
said stacking conveyors are set so as to make a reciprocating motion together within a horizontal plane perpendicular to said conveying direction; and
said stacking conveyors are alternately positioned in the empty-bag receiving position as a result of said reciprocating motion;
so that when one of the stacking conveyors is in said receiving position, the other stacking conveyor is in a non-receiving position on either the left or right; and
wherein
a second conveyor which alternatively receives empty-bag groups from said pair of stacking conveyors is disposed in front of said pair of stacking conveyors;
a conveying direction of said second conveyor is set to be parallel to said conveying direction of said stacking conveyors;
said second conveyor is devised so as to make a reciprocating motion in a horizontal plane perpendicular to said conveying direction; and
said second conveyor is alternately positioned by said reciprocating motion in a position in front of said stacking conveyor that is in said non-receiving position.

20. The apparatus for supplying empty-bag group according to claim 13, wherein
a pair of said stacking conveyors are disposed side by side;
said stacking conveyors are set so as to make a reciprocating motion together within a horizontal plane perpendicular to said conveying direction;
said stacking conveyors are alternately positioned in the stacked assembly receiving position as a result of said reciprocating motion;
so that when one of the stacking conveyors is in said receiving position; the other stacking conveyor is in a non-receiving position on either the left or right; and
wherein
a second conveyor which alternatively receives empty-bag groups from said pair of stacking conveyors is disposed in front of said pair of stacking conveyors;
a conveying direction of said second conveyor is set to be parallel to said conveying direction of said stacking conveyors;
said second conveyor is devised so as to make a reciprocating motion in a horizontal plane perpendicular to said conveying direction; and
said second conveyor is alternately positioned by said reciprocating motion in a position in front of said stacking conveyor that is in said non-receiving position.

21. The apparatus for supplying empty-bag group according to claim 19, wherein when said second conveyor is positioned in a position in front of said stacking conveyor that is in said non-receiving position on either the left or right, said second conveyor is connected to the rear portion of the conveyor of the conveyor magazine type bag supply apparatus of a bag filling packaging machine.

22. The apparatus for supplying empty-bag group according to claim 20, wherein when said second conveyor is positioned in a position in front of said stacking conveyor that is in said non-receiving position on either the left or right, said second conveyor is connected to the rear portion of the conveyor of the conveyor magazine type bag supply apparatus of a bag filling packaging machine.

23. The apparatus for supplying empty-bag group according to any one of claims 5, 6, 8, 11 and 13, further comprising a rising-and-lowering conveyor provided in front of said stacking conveyor, wherein
said rising-and-lowering conveyor can make a forward and reverse conveying operation and can also be raised and lowered; and
said rising-and-lowering conveyor is positioned at a height that is on the same level as that of said stacking conveyor when said rising-and-lowering conveyor is in a ascended position, so that empty-bag groups can be received from said stacking conveyor; and
said rising-and-lowering conveyor is positioned at a lower height than that of said stacking conveyor when said rising-and-lowering conveyor is in a descended position, so that said rising-and-lowering conveyor is connected to the rear portion of the conveyor of the conveyor magazine type bag supply apparatus of a bag filling packaging machine.

24. The apparatus for supplying empty-bag group according to claim 23, wherein
said rising-and-lowering conveyor is disposed so that said rising-and-lowering conveyor is swingable upward and downward about an end portion thereof that is located on an opposite side from said stacking conveyor side, thus making it possible for said end portion of said rising-and-lowering conveyor that is located on said stacking conveyor side to be raised and lowered.

25. An apparatus for supplying empty-bag group comprising:
a first conveyor which is driven in a conveying operation at a constant speed so that said first conveyor conveys empty bags parallel to a direction of length of bags and toward a bottom side of bags and releases said bags from a front end thereof;
an empty-bag supply means which supplies empty bags manufactured by a bag-making machine one at a time at a specified pitch to said first conveyor;
a stacking tray which is provided beneath said first conveyor and receives empty bags released from said first conveyor; and
a conveying means which conveys said stacking tray;
wherein
a front end position of said first conveyor is movable back and forth along a conveying direction of said first conveyor; and
said front end position is caused to move toward bag mouths side either continuously or intermittently by a specified distance at a time at said specified pitch, thus forming an empty-bag group, in which a specified number of empty bags are stacked with upper bags being successively shifted by a specified distance in a direction of bag mouths, on said stacking tray.

26. The apparatus for supplying empty-bag group according to claim 25, wherein
said first conveyor is a slide conveyor with a front end thereof being slidable along said conveying direction intermittently and/or continuously.

27. An apparatus for supplying empty-bag group comprising:
an empty-bag supply means which supplies empty bags manufactured by a bag-making machine to a specified position one at a time at a specified pitch;
a stacking tray to which empty bags are supplied from said empty-bag supply means; and
a moving means which moves said stacking tray;
wherein
a direction of movement of said stacking tray caused by said moving means is set to be parallel to a direction of length of said empty bags; and
said moving means moves said stacking tray toward bottoms side of empty bags either continuously at a specified speed or intermittently by a specified distance at a time at said specified pitch, thus forming an empty-bag group, in which a specified number of empty bags are stacked with upper bags being successively shifted a specified distance at a time in a direction of bag mouths, on said stacking tray.

28. An apparatus for supplying empty-bag group comprising:
an empty-bag supply means which supplies empty bags manufactured by a bag making machine to a specified position one at a time at a specified pitch;
an empty-bag holding device which can make a reciprocating motion parallel to a direction of length of said empty bags, is alternately positioned in a fixed initial position and a reciprocating position, and has a shutter means that can be freely opened and closed, so that said empty-bag holding device accommodates and holds an empty bag when said shutter means is closed and releases an empty bag downward when said shutter means is opened; and
a stacking tray which is provided beneath said empty-bag holding device and receives an empty bag released from said empty-bag holding device; and
a conveying means which conveys said stacking tray;
wherein said empty-bag holding device:
receives an empty bag from said empty-bag supply means in a state in which said shutter means is closed in said initial position;
moves to said reciprocating position;
opens said shutter means in said reciprocating position and releases said empty bag onto said stacking tray; and
shifts said reciprocating position toward bag mouths side by a specified distance with each reciprocating motion;
thus forming an empty-bag group, in which a specified number of empty bags are stacked with upper bags successively shifted a specified distance at a time in a direction of bag mouths, on said stacking tray.

29. An apparatus for supplying empty-bag group comprising:
an empty-bag supply means which supplies empty bags manufactured by a bag making machine to a specified position one at a time at a specified pitch;
an empty-bag stacking device which can make a reciprocating motion parallel to a direction of length of said empty bags, and has a shutter means that can be freely opened and closed, so that said empty-bag stacking device closes said shutter means to receive empty bags from said empty-bag supply means and stacks a specified number of said empty bags, and said empty-bag stacking device opens said shutter means to release a stacked assembly thus obtained downward;
a stacking tray which is provided beneath said empty-bag stacking device so that said stacking tray receives a stacked assembly of empty bags that are released from said empty-bag stacking device and stacks an empty-bag group comprising a plurality of stacked assemblies; and
a tray conveyor which conveys said stacking tray and is disposed so that a conveying direction of said tray conveyor and a movement direction of said empty-bag stacking device are parallel;
wherein
said empty-bag stacking device is caused to move toward bottoms side of bags either continuously at a constant speed or intermittently by a specified distance at a time at said specified pitch when empty bags are received from said empty-bag supply means, thus forming a stacked assembly of empty bags, in which a plurality of empty bags are stacked with upper bags being successively shifted a specified distance at a time toward bag mouths, inside said empty-bag stacking device; and
said tray conveyor makes a conveying operation each time one of said stacked assemblies is received, and stacks said stacked assemblies on said stacking tray so that lowermost bag of a stacked assembly that is received next is shifted by a specified distance in a direction of bag mouth with respect to an uppermost bag of a stacked assembly received previously.

30. The empty-bag group supply apparatus according to any one of claims 5, 6, 25 and 26, further comprising an empty-bag stopper provided in a position located a specified distance in front of a front end position of said first conveyor, said empty-bag stopper being contacted by a tip end of an empty bag released from said first conveyor, thus positioning the empty bag that is released from said first conveyor.

31. The empty-bag group supply apparatus according to any one of claims 5, 6, 25 and 26, further comprising an empty-bag holding device provided in front of a front end position of said first conveyor, said empty-bag holding device having a shutter means that can be freely opened and closed, so that said empty-bag holding device accommodates and holds an empty bag released from said first conveyor when said shutter means is closed and releases an empty bag downward when said shutter means is opened, thus positioning the empty bags released from said first conveyor.

32. The empty-bag group supply apparatus according to any one of claims 5, 6, 8 through 12 and 25 through 27, wherein said empty-bag supply means is provided with an empty-bag holding device which has a shutter means that can be freely opened and closed, so that said empty-bag supply means accommodates and holds an empty bag supplied when said shutter means is closed and releases an empty bag downward when said shutter means is opened.
